(19) United States
(12) Patent Application Publication
(10) Pub. No.: US 2022/0400696 A1
(43) Pub. Date: Dec. 22, 2022

(54) PLANT-BASED CHEESE PRODUCT

(71) Applicant: University of Guelph, Guelph (CA)

(72) Inventors: Alejandro Marangoni, Guelph (CA); Kristin Mattice, Guelph (CA)

(21) Appl. No.: 17/839,307

(22) Filed: Jun. 13, 2022

Related U.S. Application Data
(63) Continuation-in-part of application No. PCT/CA2020/051711, filed on Dec. 11, 2020.
(60) Provisional application No. 62/947,223, filed on Dec. 12, 2019.

(51) Int. Cl. A23C 20/02

(52) U.S. Cl. CPC A23C 20/025

(57) ABSTRACT

A novel plant-based cheese product is provided comprising a plant prolamin combined with a fat, and a structural component in water, to yield a cheese product comprising a prolamin non-covalent network. The cheese product exhibits one or more characteristics such as stretchable in an amount of about 100% in a linear direction from a resting or baseline position without breaking at a temperature in the range of 40-80° C., and/or a melting profile that mimics cheese. A method of making the cheese product is also provided.

### CROSS REFERENCE TO RELATED APPLICATIONS

The present application is a U.S. continuation-in-part under 35 U.S.C. § 365(c) and § 120, of International Application No. PCT/CA2020/051711, filed Dec. 11, 2020, which claims the priority of U.S. provisional patent application 62/947,223 filed on Dec. 12, 2019, entitled “Plant-based cheese product”, the entire contents of each of which are herein incorporated by reference.

### FIELD OF THE INVENTION

The present invention generally relates to plant-based products, and in particular, to plant-based products that resemble cheese and cheese-like foodstuffs.

### SEQUENCE LISTING

A Sequence Listing submitted herewith as an ASCII text file via EFS-Web is hereby incorporated by reference in accordance with 35 U.S.C. § 1.52(e). The name of the ASCII text file for the Sequence Listing is 106753_731177 SequenceListin.txt. The size of the ASCII text file is 3 KB and was created on Jan. 11, 2021.

### BACKGROUND OF THE INVENTION

The increasing awareness that animal products are far from sustainable and impractical for feeding the growing population has resulted in a great demand for plant-based products. While this trend has put a heavy focus on the formulation of highly sought-after meat analogues, the development of plant-based dairy alternatives is also greatly desired. For example, plant-based milk alternatives, such as almond and soy, have had noteworthy success and are now staples in the market. In contrast, currently available plant-based cheeses (sometimes referred to as non-dairy cheeses) leave something to be desired in terms of the functionality and sensory properties. Specifically, the property that many plant-based cheeses lack is high temperature melt, stretch and flow functionality which is desirable particularly in plant-based cheddar and mozzarella alternatives.

The melting functionality and sensory qualities of food products at high temperatures is often attributed to the melting of solid fat. In the case of cheese, milk-fat does melt and exists in a completely liquid state once temperatures above 40° C. have been reached. However, the melting of cheese does not typically refer to the traditional definition of melting, i.e. transition of a material from a solid to a liquid state. Instead, cheese meltability refers to the ability of cheeses to flow and stretch at greater temperatures. This stretch and flow functionality is due to the casein networks in cheese, which provide structure to the cheese matrix through casein-casein interactions. Typically, casein networks in cheese are linked primarily via non-covalent interactions, but the strength of the network depends on the production conditions specific to the variety of cheese. A cheese will stretch when the casein-casein interactions are sufficiently weakened with increasing temperature such that the material can exhibit a greater ability to dissipate applied energy. However, the interactions are only weakened and not completely lost, preventing the material from becoming completely viscous. This behaviour is notably reliant on the absence of covalent crosslinks, as cheeses that contain either naturally-occurring disulphide bonds or enzymatically catalyzed crosslinks do not display meltability or stretchability.

Matching the functionality of casein in cheese using plant-based proteins has proven to be extremely challenging. In fact, the lack of knowledge surrounding plant-based proteins capable of mimicking this functionality has caused the products currently available to turn to the use of non-protein ingredients to fill structural requirements. As a result, many plant-based cheeses contain significant amounts of coconut oil, palm oil, or other plant-based solid fat sources that will melt with increasing temperature. While this does mimic the melting behaviour of milk fat, it does not account for the stretch and flow characteristics. The products currently on the market rely on the contribution of viscosity from different starches, gums and gelling agents to provide some semblance of stretching. Despite the identified functional importance of protein in cheeses, many plant-based cheese products contain minimal to no protein, and those that do are supplementing it for the purpose of nutrition rather than functionality. This opens up significant opportunity in the creation of melt-able plant-based cheese products containing plant-based proteins capable of replicating the behaviour of casein.

In general, plant-based meat products contain primarily soy, pea and wheat proteins for functionality. Since these proteins do not lend themselves to the application of melt-able plant-based cheeses, it would be desirable to develop a product that possesses cheese-like functionality.

### SUMMARY OF THE INVENTION

A novel plant-based food product has now been developed comprising a plant prolamin having unique properties. The food product is functionally similar to cheese with respect to, for example, properties such as meltability and stretchability.

Thus, in one aspect of the invention, a plant-based cheese product is provided comprising a plant prolamin combined with a fat, and a structural component in water, to yield a cheese product comprising a prolamin non-covalent network.

In another aspect, a product comprising a prolamin combined with a plasticizer is provided.

In another aspect of the invention, a method of making plant-based cheese product is provided comprising the steps of:
i) combining the structural component with water and heating to form a mixture having a viscosity that permits formation of a non-covalent prolamin network at a temperature greater than the glass transition temperature of the prolamin;
ii) combining the mixture with the prolamin, fat and optionally a plasticizer, at a temperature above the glass transition temperature of the prolamin to form a non-covalent prolamin network; and
iii) cooling the mixture to provide the cheese product.

These and other aspects will become apparent in the detailed description that follows by reference to the following figures.

### BRIEF DESCRIPTION OF THE FIGURES

FIG. 1 graphically illustrates amplitude sweeps of a) zein at different storage time points; and b) gluten network and cheddar cheese (T=50° C.; ω=3 rad/s)

FIG. 2 illustrates stress versus strain plots of a) zein at different storage time points; and b) gluten network and cheddar cheese (T=50° C.; ω=3 rad/s)

FIG. 3 illustrates frequency sweeps of a) zein at different storage time points; and b) gluten network and cheddar cheese (T=50° C.; γ=0.01%)

FIG. 4 illustrates temperature sweeps of a) zein at different storage time points; and b) gluten network and cheddar cheese (γ=0.01%; ω=3 rad/s)

FIG. 5 illustrates a modified sliding friction rig set up affixed to a texture analyzer with a 30 kg load cell to measure the stretchability or extensibility of cheese products;

FIG. 6 graphically illustrates temperature sweeps of cheese and plant-based cheese containing a) 0% or 10% zein; b) 20% or 30% zein; c) plant-based cheddar cheese (PBC) or cheddar cheese (CC); d) pea protein isolate (PPI) or gluten (GC), where γ=0.01% and ω=3 rad/s.

FIG. 7 graphically illustrates: a) amplitude sweeps, and b) stress versus strain curves for 30% zein cheese, plant-based cheddar cheese (PBC) and cheddar cheese (CC), where T=50° C. and ω=3 rad/s.

FIG. 8 graphically illustrates texture profile analysis parameters at both 5° C. and 50° C. of cheese and plant-based cheese samples containing: 0% zein (control), 10% zein, 20% zein, 20% zein, 30% zein, gluten, pea protein isolate (PPI), plant-based cheddar cheese (PB Cheddar) and cheddar cheese (cheddar). Error bars represent the standard error based on the analysis of 7-9 reps of each sample at each temperature.

FIG. 9 illustrates stretchability profiles of cheese and plant-based cheese samples containing: 0% zein, 10% zein, 20% zein, 20% zein, 30% zein, cheddar cheese (CC), plant-based cheddar cheese (PBC), pea protein isolate (PPI) and gluten (GC).

FIG. 10 provides a table showing the amino acid compositions of zeins, deduced from cDNA clones (mol %).

FIG. 11 illustrates an amino acid sequence of α-zein.

FIG. 12 illustrates the melting profile of products with zein, PPI, gluten and no protein.

FIG. 13 graphically illustrates the hardness of products with zein, PPI, gluten and no protein at 5° C. and 50° C.

FIG. 14 illustrates the stretch properties of products with zein, PPI and gluten.

FIG. 15 illustrates the melting profile of a zein product compared to commercial dairy cheeses and commercial plant-based cheeses.

FIG. 16 graphically illustrates the hardness of a zein product compared to cheddar cheese and commercial plant-based cheeses.

FIG. 17 illustrates the stretch properties of a zein product compared to cheddar cheese and a commercial plant-based cheese.

FIG. 18 graphically illustrates the hardness of zein products at 5° C. and 50° C. in which the zein content is 10%, 15%, 20% and 30% by weight of the product.

FIG. 19 illustrates the melting profile of zein in the presence of different plasticizing agents at varying concentrations.

FIG. 20 illustrates the melting profile of zein products comprising non-hydrolyzed and partially hydrolyzed zein.

FIG. 21 illustrates the melting profile of zein products comprising malic, citric or tartaric acid, or no acid.

FIG. 22 graphically illustrates the hardness of zein products at 5° C. and 50° C. comprising malic, citric or tartaric acid, or no acid.

FIG. 23 illustrates the stretch properties of a zein product with and without malic acid.

FIG. 24 graphically illustrates the effect of salt on a zein product with and without malic acid.

FIG. 25 illustrates the melting profile of zein products comprising different fats.

FIG. 26 graphically illustrates the hardness of zein products at 5° C. and 50° C. comprising different fats.

FIG. 27 graphically illustrates the hardness of zein products at 5° C. and 50° C. comprising different gelling/thickening agents.

FIG. 28 illustrates the melting profile of zein products comprising different gelling/thickening agents.

FIG. 29 graphically illustrates the viscosity of over time of zein products comprising different combination of gelling/thickening agents.

### DETAILED DESCRIPTION OF THE INVENTION

A plant-based food product is provided comprising a plant prolamin combined with a fat and a structural component in water to yield a product comprising a prolamin non-covalent network. The food product preferably exhibits at least one cheese-like property, for example, characteristics of stretch, rheological melting profile, loss of shape melting characteristic and/or hardness of cheese. Thus, the present food product is referred to herein as a “cheese” product.

In one embodiment, the cheese product is stretchable in an amount of at least about 100% in a linear direction from a resting or baseline position without breaking at a temperature between about 40 to 80° C., preferably at a temperature of 50-60° C.

In another embodiment, the cheese product exhibits a melting profile which correlates with natural cheese. For example, at room temperature, the tan δ (G″/G′) of the cheese product is in the range of 0.2 to 0.5, and increases on heating such that below 70° C., G′>G″ (tan δ is >0.2 and <1), at about 70° C., G′=G″ (tan δ is 1), and above 70° C., G′<G″ (tan δ ranges from greater than 1 to about 2 at temperatures of about 70 ° C. to 100 ° C.). Thus, the melting profile of the cheese product may be such that tan δ increases from about 0.2-0.5 at room temperature to about 2.0 as temperature is increased up to about 100° C. Alternatively, the melting profile of the cheese product is such that storage moduli (G′) is greater than loss moduli (G″), and tan δ (G″/G′) is greater than 0.5 but less than 1.0.

In another embodiment, the cheese product exhibits a decrease in hardness and loss of shape at increased temperature, e.g. a decreased hardness at 50° C. as compared to hardness at 5° C. to mimic the softening of cheese at increased temperatures. The extent of decreased hardness will vary with the type of cheese product (i.e. a harder or softer cheese). Hardness is measured as the maximum force recorded during the first compression of a double compression cycle, taken at different temperatures to quantify softening that occurs. Preferably, the cheese product exhibits a decrease in hardness at increased temperatures, from a hardness of 2000 to 20,000 g or greater at room temperature (e.g. 5 kg, 10 kg, 15 kg or greater), while maintaining a hardness of at least about 100 g, e.g. 500-1000 g at increased temperatures.

In another embodiment, regarding loss of shape, the product exhibits melting measured by an increase in a dimension of its shape when exposed to an increase in temperature. The increase may be an increase in a dimension such as, but not limited to, diameter, cross-section or length. For example, the product, when in the shape of a cylinder exhibits an increase in diameter at a temperature in the range of 40 to 80° C., e.g. an increase in diameter of at least 50% or greater, e.g. 100%, 200% or greater.

The present cheese product comprises a plant-based prolamin storage protein that is able to form a non-covalent linked protein network, similar to that formed by casein in natural cheese, which is weakened, but not eliminated, at increased temperatures. The non-covalent linked network is formed by hydrophobic interactions and hydrogen bonding as opposed to covalent disulfide linkages. It is the formation of this non-covalent network that provides the stretchability of the present product that is characteristic of natural cheese. The plant prolamin for use in the present cheese product will, thus, generally form networks that exhibit storage moduli (G′) greater than loss moduli (G″), i.e. G′>G″, such that, for example, the tan δ (G″/G′) is greater than 0.5 but less than 1.0.

Examples of suitable plant-based prolamins for use in the present cheese product include, but are not limited to, prolamin proteins from a cereal grain plant such as wheat, barley, rye, corn, sorghum, oats and the like. Thus, suitable prolamins include, but are not limited to, gliadin, hordein, secalin, zein, kafirin, avenin, or any combination thereof. As one of skill in the art will appreciate, the prolamin may be a natural protein or a synthetically produced protein.

In addition, suitable plant prolamin proteins for use in the present cheese product may be functionally equivalent derivatives of a naturally occurring prolamin protein. The term “functionally equivalent” as used herein with respect to plant prolamins refers to naturally or non-naturally occurring variants of an endogenous plant prolamin that retains the ability of the natural prolamin to form a non-covalent linked protein network. The variant need not exhibit identical activity to an endogenous prolamin, but will exhibit sufficient activity to render it useful to produce the present cheese product. Such functionally equivalent variants may result naturally from alternative splicing during transcription or from genetic coding differences and may retain significant sequence homology with a wild-type prolamin, e.g. at least about 70% sequence homology, preferably at least about 80% sequence homology, and more preferably at least about 90% or greater sequence homology. Additionally, such modifications may result from non-naturally occurring synthetic alterations made to a natural prolamin to bestow on the variant more desirable characteristics for use in the present cheese product, for example, enhanced ability to form a non-covalent network. In one embodiment, the functionally equivalent derivative may be a prolamin analogue that incorporates one or more amino acid substitutions, additions or deletions. Amino acid additions or deletions include both terminal and internal additions or deletions. Examples of suitable amino acid additions or deletions may include those that occur at positions within the protein that are not closely linked to activity, or additions or deletions at the N- or C- terminus of the protein. Amino acid substitutions may include conservative amino acid substitutions such as the substitution of a non-polar (hydrophobic) residue such as alanine, isoleucine, valine, leucine or methionine with another non-polar (hydrophobic) residue; the substitution of a polar (hydrophilic) residue with another such as between arginine and lysine, between glutamine and asparagine, between glutamine and glutamic acid, between asparagine and aspartic acid, and between glycine and serine; the substitution of a basic residue such as lysine, arginine or histidine with another basic residue; or the substitution of an acidic residue, such as aspartic acid or glutamic acid with another acidic residue.

A functionally equivalent derivative also includes a prolamin in which one or more of the amino acid residues therein is chemically derivatized. The amino acids may be derivatized at the amino or carboxy groups, or alternatively, at the side “R” groups thereof. Derivatization of amino acids within the protein may yield a protein with enhanced properties. Such derivatized molecules include for example, those molecules in which free amino groups have been derivatized to form, for example, amine hydrochlorides, p-toluene sulfonyl groups, carbobenzoxy groups, t-butyloxycarbonyl groups, chloroacetyl groups or formyl groups. Free carboxyl groups may be derivatized to form, for example, salts, methyl and ethyl esters or other types of esters or hydrazides. Free hydroxyl groups may be derivatized to form, for example, O-acyl or O-alkyl derivatives. The imidazole nitrogen of histidine may be derivatized to form N-im-benzylhistidine. Also included as derivatives are those proteins which contain one or more naturally occurring amino acid derivatives of the twenty standard amino acids, for example: 4-hydroxyproline may be substituted for proline; 5-hydroxylysine may be substituted for lysine; 3-methylhistidine may be substituted for histidine; homoserine may be substituted for serine; and ornithine may be substituted for lysine. Terminal derivatization of the protein to protect against chemical or enzymatic degradation is also encompassed including acetylation at the N-terminus and amidation at the C-terminus of the protein.

Synthetic prolamins, or functionally equivalent variants thereof, may be made using automated systems based on standard, well-established solid-phase peptide synthesis methods, such as BOC and FMOC methods. Prolamins or variants thereof may also be made using any one of a number of suitable techniques based on recombinant technology. It will be appreciated that such techniques are well-established by those skilled in the art, and involve the expression of prolamin-encoding nucleic acid in a genetically engineered host cell. Nucleic acid encoding a prolamin may be synthesized de novo by automated techniques well-known in the art given that the protein and nucleic acid sequences are known.

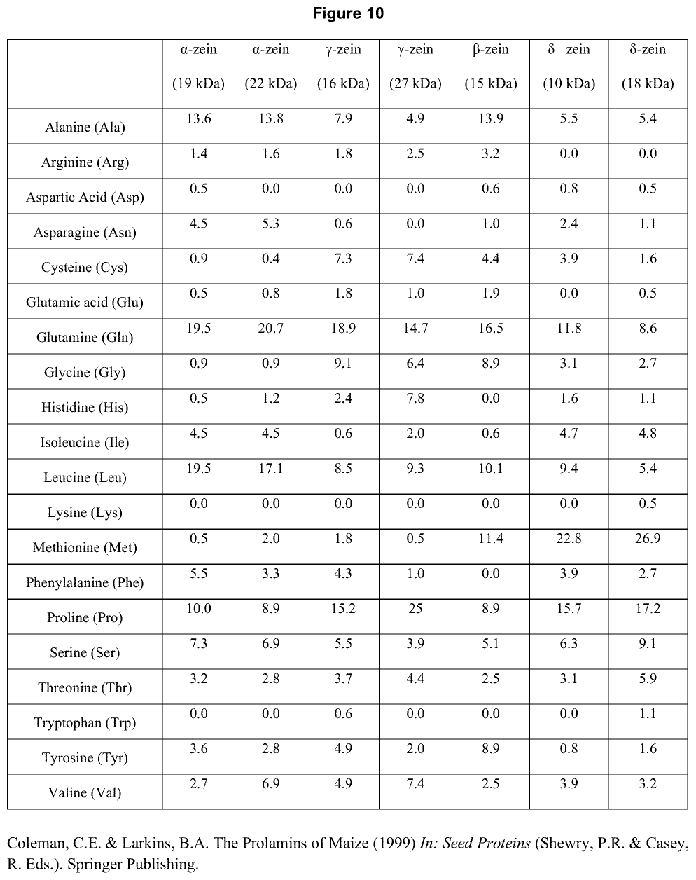

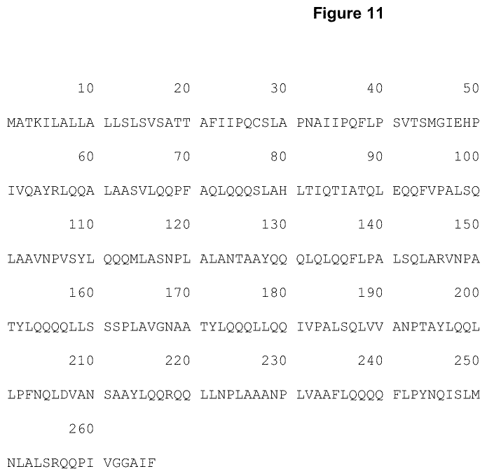

In one embodiment, the present cheese product comprises the plant prolamin storage protein, zein. The term “zein” is meant to encompass a prolamin isolated from corn having a molecular weight in the range of from 20 to 30 kDa, preferably, 22 to 25 kDa, composed of a high amount of hydrophobic amino acids, such as glutamine, leucine, proline and alanine, e.g. greater than 50% hydrophobic amino acid content, and functionally equivalent variants thereof as described above. The zein used herein may comprise a mixture of zein proteins, e.g. a mixture of proteins with various molecular size, solubility, and charge such as a mixture of two or more of α-zein, β-zein, γ-zein and δ-zein, or may comprise a single zein protein, provided that the mixture comprises minimal cysteine residues to minimize or prevent the formation of a covalent linked network, e.g. 1 or 2 cysteine residues per zein subunit. The amino acid composition of various zeins that may be used in the present product is provided in FIG. 10. In one embodiment, the zein protein comprises primarily α-zein, e.g. greater than 85% α-zein, or a functionally equivalent variant of α-zein. FIG. 11 illustrates an amino acid sequence of α-zein (22 kDa). Functionally equivalent variants may incorporate conservative amino acid substitutions, substitution with derivatized amino acids, or amino acid additions or deletions, for example at the termini thereof.

The present cheese product comprises a prolamin in an amount suitable to render the cheese product to be stretchable to mimic this property in cheese. Stretchability is based on the extensional rheology of the product, and the extensional flow of the product in response to the application of a linear pulling force (i.e. stretching) in a particular direction. In one embodiment, the cheese product is stretchable in an amount of about 100% in a linear direction from a resting or baseline position, i.e. a position in which the product is not stretched or under any force or tension, without breaking at a temperature within the range of about 40-80° C. Preferably, the present cheese product is stretchable in a linear direction in an amount of greater than 100% from a resting position, such as an amount of at least 200%, 300%, 400%, 500%, or more at a temperature of about 50-55° C. Stretchability may also be expressed as a length. Thus, in another embodiment, the present cheese product is stretchable so as to increase its length at least 1 time from its length in a resting position, and preferably increase its length at least about 2 or 3 times its length at rest, without breaking at a temperature within the range of about 40-80° C., e.g. such as about 50° C. In this regard, the amount of prolamin in the product will vary with the prolamin used and the amounts of the other ingredients in the product. The amount of prolamin may be in the range of about 10-40% by weight (i.e. % wt) of the cheese product, preferably 15-30% by weight, such as 20-25% by weight of the cheese product.

The cheese product also comprises an edible fat component. The fat component comprises saturated fats, unsaturated fats (either monounsaturated or polyunsaturated) or a mixture thereof. The fat component may be a vegetable fat or oil. Examples of suitable fats or oils include, but are not limited to sunflower oil, canola oil, safflower oil, soybean oil, avocado oil, olive oil, corn oil, flaxseed oil, almond oil, coconut oil, peanut oil, pecan oil, cottonseed oil, algal oil, palm oil, palm stearin, palm olein, palm kernel oil, rice bran oil, sesame oil, butteroil, cocoa butter, grape seed oil, hazelnut oil, brazil nut oil, linseed oil, acai palm oil, passion fruit oil, walnut oil, shea butter, shea stearin, shea olein, palm kernel stearin, palm kernel olein, and mixtures thereof. As one of skill in the art will appreciate, the vegetable oils used may vary with respect to their triglyceride content, for example, to provide enhanced oxidative stability. Accordingly, the oil used may be high oleic acid-containing oil such as high-oleic sunflower, high-oleic & high-stearic sunflower oil, high-oleic soybean, high-oleic canola, high-oleic safflower oil, and mixtures thereof. The term “high-oleic acid” refers to an oil containing an increased amount of oleic acid as compared to the typical oleic acid content of the oil. This increase may be a 20% or more increase in oleic acid content from the typical amount in a given oil.

The fat/oil component comprises 0.1-30% by weight of the cheese product, preferably 10-30% by weight, such as 15-25% by weight of the product. Preferably, the cheese product comprises a combination of saturated and unsaturated oil/fat that corresponds with the fat content in cheeses, e.g. a ratio of about 0.5-1 saturated fat to unsaturated fat.

As will be understood by one of skill in the art, the melting behavior of a cheese product may be modified by altering the fat content of the cheese product. To enhance melting behavior, a cheese product will include a fat content with a greater amount of a solid fat, a fat which is solid at fridge temperatures (about 4-6° C.), but which begins to melt into a liquid state once heated above ambient temperatures (e.g. about 20-24° C.). Further, the fat content of the cheese may be altered in order to provide a cheese product that mimics a particular cheese type. For example, a cheese product will comprise a greater amount of a solid fat to mimic a harder cheese such as parmesan or old cheddar, while a cheese product that mimics a softer cheese, such as Brie, Camembert or gorgonzola, will comprise a greater amount of a liquid (oil) fat. Altering the fat content is also useful to produce a “low calorie” or “heart healthy” cheese product, i.e. providing a cheese product with a lower fat content, or at least a lower saturated fat content.

The cheese product also comprises a structural component. The structural component comprises thickening and/or gelling agents. The suitable structural component provides viscoelasticity while supporting (and not inhibiting) the formation of non-covalent networks within the matrix of the product, e.g. the formation of non-covalent prolamin networks within the aqueous matrix. The structural component, thus, contributes to the structure of the product, and functions to retain moisture and emulsify the fat component within the system. To permit the formation of non-covalent prolamin networks, the structural component will generally gel at a temperature at or below the glass transition temperature of the prolamin, such that the viscosity of the structural component on addition of prolamin at a temperature above its glass transition temperature allows the formation of the non-covalent prolamin network.

Examples of thickening and/or gelling agents suitable for use in the present product include, but are not limited to, starches such as arrowroot, cornstarch, katakuri starch, potato starch, sago, wheat flour, almond flour and tapioca starch; starch derivatives such as oxidized starch, phosphorylated starch and hydroxyethyl starch; modified or pre-gelatinized starches (i.e. cold swelling or rapid swelling starches); high amylopectin or waxy starches (e.g. starches comprising an amylopectin content of at least about 85% or more, e.g. 90%, 95% or more of the starch); pre-gelatinized high amylopectin (AP) starches; starches which are essentially uncrosslinked, i.e. comprise little or no crosslinking (which may have a detrimental effect on stretch properties of the cheese product); microbial and vegetable gums such as alginin, guar gum, locust bean gum, gellan gum, tara gum, Arabic gum, Konjac and xanthan gum; proteins such as collagen, egg white and gelatin; or sugar polymers such as agar, carboxymethyl cellulose, pectin and carrageenan (e.g. kappa, iota, lambda); and mixtures thereof.

In one embodiment, the structural component comprises a combination that provides viscoelasticity (e.g. one or more agents such as tapioca or potato starch, agar or pectin) and permits the prolamin, such as zein, to form networks via non-covalent linkages (e.g. one or more agents such as Konjac, locust or xanthan gum, corn starch or potato starch) which are important to the properties of the cheese product. The amount of each may be varied depending on the desired properties of product. For example, for a combination of tapioca and corn starch, a ratio of about 2:1 tapioca to corn starch may be used; however, this ratio can be altered in order to change the properties of the cheese product. Other combinations of thickening and/or gelling agents may also be utilized, for example, combinations of starch, such as tapioca or corn starch, with a gum such as locust bean gum, agar with a gum such as Konjac gum, a combination of starches, or a combination of gums.

The amount of structural component within the cheese product is an amount in the range of about 1 to 30% by weight, preferably an amount in the range of 5-15% by weight. The amount of structural component(s) in the cheese product may generally be an amount that provides a ratio of structural component to fat in the range of about 1:2 to 1:4 structural component to fat, such as 1:3 structural component to fat.

The cheese product may optionally include a plasticizer to increase the melt and stretch functionality thereof. Suitable plasticizers for inclusion in the present cheese product are food grade plasticizers including, but not limited to, food grade acids such as levulinic acid, palmitic acid, stearic acid, and oleic acid, and food grade carboxylic acids, such as citric, malic, lactic, acetic, oxalic and tartaric acid, glycerol, polyethylene glycol, triethylene glycol, ethylene glycol, sorbitol, sugars such as fructose, galactose and glucose, and mixtures thereof. The plasticizer or mixture of plasticizers may be present in the cheese product in an amount in the range of 0-5% by weight of the product, preferably in an amount of 1-4% by weight, such as 2-3% by weight.

Increased melt and stretch in the cheese product may also be achieved by partial hydrolysis of the prolamin using methods well-known in the art. Briefly, the prolamin may be partially hydrolyzed by acid hydrolysis or alkaline hydrolysis, followed by precipitation using a base or acid, respectively.

In another aspect, thus, an edible plasticized product is provided for use in foods, to provide texture, as a substitute for fat-containing ingredients such as cheese, and/or to replace animal-based ingredients (i.e., to provide a vegan product). The product comprises a prolamin combined with a plasticizer to provide a product which exhibits a melting profile in which G′ and G″ are reduced at elevated temperatures, e.g., temperatures of between 40-80° C. At room temperature, G′ and G″ values are generally greater than 10⁴ Pa, in the range of 10⁴ to 10⁶ Pa, and are reduced to less than 10⁴ Pa as temperature is increased, for example, in the range of 10² to less than 10⁴ Pa. This plasticized product comprises up to about 5% by weight of a food-grade plasticizer, such as food-grade acids, including carboxylic acids, or other plasticizers as herein described. The properties of this plasticized product may be altered by inclusion of one or more additional ingredients, such as fats, structuring agents, flavorants, nutrients, fillers and the like, as described herein.

The cheese product may include additional ingredients including, but not limited to, flavorants, colorants, preservatives, anti-oxidants, nutrients, fillers, etc.

Flavorants may include salt, sugar, spices, herbs and the like. Flavorants may also include cheese powders and/or cheese flavors that mimic flavors that result from the breakdown of casein in natural cheese, and may include casein peptides and amino acids that provide a salty, sour, bitter or sweet taste, and free fatty acids such as butyric, lactic and capric acids which provide characteristic cheese flavor. Enzyme-modified cheese flavor may also be used to provide a stronger flavor.

Examples of preservatives that may be used include, but are not limited to, sodium benzoate, sodium and calcium propionate, sorbic acid, ethyl formate, and sulfur dioxide.

Examples of anti-oxidants that may be used include, but are not limited to, ascorbic acid, tocopherols, butylated hydroxyanisole and propyl gallate.

Nutrients that may be included in the present cheese include vitamins (e.g. vitamin A, C, E, K, D, thiamin (vitamin B1), riboflavin (vitamin B2), niacin (vitamin B3), vitamin B6, folic acid (vitamin B9) and/or vitamin B12, and mixtures thereof), minerals (e.g. calcium, phosphorus, magnesium, sodium, potassium, chloride, iron, zinc, iodine, selenium, copper and mixtures thereof), and protein isolates such as pea protein, soy protein, fava protein, yeast protein and other organisms, corn protein, wheat protein, rice protein, canola protein, peanut protein, bean protein, lentil protein, pumpkin seed, rice, brown rice, peanut, almond, chia seed, flax seed and combinations thereof. The protein source may be non-hydrolyzed, partially hydrolyzed or hydrolyzed and may be in the form of an intact protein, amino acid or peptide.

Such additional ingredients may each be included in the present cheese product in an amount in the range of 0.01% by weight to about 5% by weight, preferably in the range of about 0.1% -2% by weight of the product.

The cheese product may also include a filler to provide volume/bulk to the cheese product while not impacting desired properties, such as rheological melting properties, hardness, stretch, shape and sliceability. Examples of suitable fillers for this purpose include, but are not limited to, consumable inert components such as microcrystalline cellulose, maltodextrin, dextrin, pea protein, soy protein, inulin, sugars and mixtures thereof. The filler may be included in the cheese product in an amount in the range of about 1-15% by weight of the cheese product, preferably about 2.5-10% by weight.

The balance of the cheese product is water. The cheese product comprises at least about 30% by wt water, such as at least about 40% by weight, e.g. at least about 50%, 60%, 70% or more. Preferably the amount of water in the cheese product is in the range of about 40-60% by weight of the cheese product. As one of skill in the art will appreciate, water content will vary with the desired characteristics of the end product. For example, a softer cheese product will generally include an increased amount of water (e.g., 50% by weight or more), while a harder cheese product will generally include less water (e.g., less than 50% by weight, such as 40-45% by weight).

The present cheese product is prepared by hydrating and heating the structural component (comprising thickening and/or gelling ingredients) to form a mixture. The gel mixture is then cooled prior to addition of the selected prolamin. The viscosity of the gel mixture may require adjustment before addition of the selected prolamin to achieve a viscosity that permits the formation of non-covalent prolamin networks when heated to a temperature above the glass transition temperature of the selected prolamin (e.g. prolamin network-forming temperature). The prolamin, fat component (melted, if solid) and optional plasticizer component are then added to the mixture at a prolamin network-forming temperature. Under optimal conditions, the viscosity of the mixture is such that it permits prolamin network formation throughout the mixture, to form a dough-like consistency.

In one embodiment, a zein cheese product is made by mixing the structural component (thickening and/or gelling ingredients) with water at a temperature in the range of 35-45° C. until blended. The mixture is then heated to a temperature of about 85-95° C. and mixing is continued at low speed for about 5-10 minutes. The structural component is then allowed to cool until reaching a temperature above the glass transition temperature of zein with constant stirring. The fat component (melted and at the same temperature as the structural component) is then added along with the zein and optional plasticizer and mixed at increasing speed for a period of time sufficient to form a product having the desired non-covalent protein networks.

The properties of the present product may be altered to provide a product that corresponds with a variety of cheese types such as semi-hard cheeses, e.g., cheddar, swiss and gouda cheese, hard cheese, e.g. parmesan or asiago, semi-soft cheese, e.g., Havarti or Jarlsberg, stretched curd cheese, e.g., mozzarella or provolone cheese, or soft cheese, e.g., Brie or gorgonzola. For example, water and fat content may be altered to provide a harder or softer variety of cheese, while the amount of prolamin and/or thickening agent may be altered to provide a product with different melt rheology and/or stretchability.

The present invention provides a novel cheese product made from a relatively inexpensive, sustainable protein source that advantageously provides the sensory properties that render the product an authentic substitute to conventional cheese. Specifically, the present prolamin cheese product displays similar properties to cheese in terms of texture, rheology, and melt-stretch qualities. The properties of the present cheese product are due, at least in part, to the fact that the prolamin naturally forms networks via non-covalent interactions within the aqueous environment of the product. Further, the option to alter the content of the present product, for example, to alter calorie, saturated fat and total fat content, relative to conventional cheese products is also a valuable benefit of the present cheese product.

In another aspect, an edible plasticized product is provided for use in foods, to provide texture, as a substitute for fat-containing ingredients such as cheese, and/or to replace animal-based ingredients (i.e., to provide a vegan product). The product comprises a prolamin combined with a plasticizer to provide a product which exhibits a melting profile in which G′ and G″ are reduced at elevated temperatures, e.g., temperatures of between 40-80° C. At room temperature, G′ and G″ values are generally greater than 10⁴ Pa, in the range of 10⁴ to 10⁶ Pa, and are reduced to less than 10⁴ Pa as temperature is increased, for example, in the range of 10² to less than 10⁴ Pa. This plasticized product comprises up to about 5% by weight of a food-grade plasticizer, such as food-grade acids, including carboxylic acids, or other plasticizers as herein described. The properties of this plasticized product may be altered by inclusion of one or more additional ingredients, such as fats, structuring agents, flavorants, nutrients, fillers and the like, as described herein.

Embodiments of the invention are described by reference to the following example which is not to be construed as limiting.

### EXAMPLE 1—PROPERTIES OF ZEIN

Maize zein was obtained from Flo Chemical Corp. (Ashburnham, Mass.). Medium cheddar cheese and gluten flour (100% vital wheat gluten) were purchased at local supermarkets.

Differential Scanning calorimetry—A Mettler Toledo differential scanning calorimeter (DSC) (Mettler Toledo, Mississauga, ON, Canada) was used to determine the glass transition temperature (Tg) of zein. The effect of water plasticization, or decrease in Tg, with increasing water activity (Aw) was observed by equilibrating powdered zein in sealed containers at 25° C. over different saturated salt solutions for three weeks: KNO₃ (Aw=0.93), KCl (aw=0.84), NaCl (Aw=0.75), Ca(NO⁻³)₂ (Aw=0.51), MgCl₂ (Aw=0.33), and LiCl (Aw=0.25). Equilibrated protein samples were weighed into aluminum crucibles (6-8 mg) and subjected to the following conditions: 5° C. for 10 minutes; 5° C. to 120° C. at 5° C./minute; 120° C. for 10 minutes; 120 to 5° C. at 10° C./minute; 5° C. for 10 minutes; 5° C. to 120° C. at 5° C./minute. The Tg was determined using STARe software (Mettler Toledo) and the exact temperature was taken at the inflection point of the reversing heat flow signal. After equilibration, the exact Aw of the zein was analyzed using an AquaLab water activity meter (Decagon Devices, Pullman, USA). Equilibration was performed in triplicate and each repetition was included as a separate point in the plot of Aw against Tg.

Proximate Analysis was carried out for zein and gluten. Ash, moisture, fat and protein content were each determined in triplicate. Carbohydrate content was determined by subtraction, with the total of all components adding to 100%. Ash content was determined through dry ashing of samples in a furnace at 550° C. for 5-8 hours. Moisture content was determined by drying samples in a vacuum oven held at 70° C. and 30 mmHg for 3-5 hours. The Soxhlet method was carried out for fat extraction, where 3-4 g of zein was weighed into dry extraction thimbles. The thimbles were then placed in the Soxhlet extraction apparatus. Approximately 200 mL of petroleum ether was poured into the flask and was heated gently to allow a continual reflux of petroleum ether for 4-5 hours. The sample was removed and the majority of petroleum ether was then poured off from the extraction chamber. The remaining petroleum ether was evaporated in a drying oven set to 60° C. Protein content was determined using the Dumas combustion method in a LECO FP-528 Protein/Nitrogen Analyzer (Leco Corporation, St. Joseph, Mich., USA). The conversion factor used to calculate protein content was 6.25 for zein, and 5.70 for gluten flour (Esen, 1980; Jones, 1931). The composition of pre-cooked chicken strips and cheddar cheese was obtained from the nutritional information on the package. The moisture content of these products was calculated by subtraction.

Protein Network Sample Preparation—Particulate zein or gluten flour was weighed into beakers and water was added in excess (at least 10:1 by weight). The proteins were stirred to thoroughly disperse within the water, and put in an incubator at 40° C. for at least 30 minutes to allow network formation. Excess water present after network formation was discarded. Zein samples were stored at 40° C. until analysis at different time points: freshly prepared that day (0 h), 24 hours (24 h), 48 hours (48 h) and one week (1 wk). Gluten network samples were stored at 40° C. and analyzed after 30 minutes.

Small Amplitude Oscillatory Dynamic Rheology—Shear oscillatory experiments were performed with a rotational rheometer (MCR 302, Anton Paar, Graz, Austria) fixed with parallel plate geometries (20 mm diameter). The geometries were fixed with adhesive 600 grit sandpaper to minimize slip during measurements. Samples were placed onto the lower plate and compressed between the plates with an axial force not exceeding 2N to avoid error, as overloading has been shown to modify the rheology (Macias-Rodriguez & Marangoni, 2016a). The parallel plates had temperature control by Peltier units located in the lower plate and the hood of the rheometer. The exposed edges of the samples were coated with mineral oil to prevent drying or hardening during testing. RheoCompass software and firmware (Anton Paar, Graz, Austria) provided the storage modulus (G′), loss modulus (G″), and shear stress (τ) values used for analysis.

Amplitude sweep tests were performed with shear strain increasing from γ=0.001% to γ=300%. The angular frequency (ω) was constant at 3 rad/s. For all samples, the temperature (T) was constant at 50° C. Frequency sweeps were performed with ω increasing from 0.1 to 60 rad/s. For all samples, γ was constant at 0.01% rad/s and T was constant at 50° C. Finally, temperature sweeps were performed with T increasing from 5 to 100° C. at a rate of approximately 5° C. per minute. The shear strain and angular frequency were constant at γ=0.01% and ω=3 rad/s, respectively.

Attenuated Total Reflectance—Fourier Transform Infrared Spectroscopy (FTIR)—Samples were compressed to thoroughly remove any unbound water prior to analysis. Infrared spectra of the different zein masses were obtained using an FTIR spectrometer (model IRPrestige-21, Shimadzu Corp., Kyoto, Japan). The FTIR was equipped with an attenuated total reflectance accessory (Pike Technologies, Madison, Wis., USA). Samples were scanned from 600 to 4000 cm⁻¹ with a 4 resolution and 32 scans per spectrum. Analysis was carried out in triplicate at ambient temperatures. Secondary structure analysis of zein fibres was conducted by deconvoluting the amide I region (1600-1700 cm⁻¹) using OriginPro software (Origin Lab Corp., Northampton, Mass., USA). The second derivative of the original spectra was used to locate each of the underlying bands, and the wavenumber position was fixed during fitting. Each band was fitted using the Lorentzian function. The secondary structural content was determined from the relative areas of the individual bands in the amide I region of zein (Li, Lim, & Kakuda, 2009; Mejia, Mauer, & Hamaker, 2007; Moomand & Lim, 2015; Zhang, Luo, & Wang, 2011).

Statistical Analysis—GraphPad Prism 5.0 (GraphPad Software, San Diego, Calif., USA) was used for statistical analysis and logarithmic transformation of data. A two-tailed unpaired t-test was performed on the secondary structure data by FTIR for each secondary structure type. The confidence level was chosen as 95%.

### Results

Proximate Analysis—Zein and gluten were analyzed to determine the crude content of protein, fat, moisture and ash (Table 1). The content of carbohydrates was determined by subtraction. The composition of cheddar cheese was included for comparison. The obtained results confirm that protein is the major component in both the powdered zein and gluten. As such, it can be assumed that the properties observed in further experiments can be primarily attributed to protein functionality. However, some differences existed between the proteins, zein had greater proportions of protein, ash and lipids, while wheat gluten had greater proportions of moisture and carbohydrates. Cheddar cheese also contained a significant amount of protein, but had a greater content of fat than protein, which must be accounted for during further analysis.

TABLE 1
Summary of Proximate analysis of gluten flour, zein and cheddar cheese

| | Gluten | | Pre-Cooked | Cheddar |
|---|---|---|---|---|
| | Flour | | Chicken | Cheese |
| Moisture | 6.7% ± 0.09 | 3.83% | 75.2% | 42.1% |
| Ash | 0.71% ± 0.02 | 1.70% | 0.4% | 0.7% |
| Fat | 0.56% ± 1.0 × 10⁻⁴ | 2.87% | 2.1% | 33.3% |
| Protein | 71.0% ± 0.11 | 87.20% | 22.3% | 23.8% |
| Carbohydrates | ~21.2% | ~4 | 0% | 0% |

Glass Transition Temperature—The Tg of zein at different water activities was observed by subjecting proteins to two heating cycles, where the proteins were heated to 120° C. in each. A peak associated with native zein protein was observed during the first heating cycle in all samples, occurring at approximately 60-65° C. This peak ultimately overlapped with the Tg in certain samples, rendering it impossible to distinguish the location of the glass transition. Therefore, the Tg was recorded during the second heating cycle for all samples. As has been shown previously, the presence of water causes a significant decrease in zein's Tg. The observed decrease had a linear relationship with increasing Aw of the sample. The lowest obtained Tg was approximately 45° C., identified when the Aw was greater than 0.8. Due to this result, further experimentation was carried out at temperatures equal to or greater than 50° C., in an excess of water, to ensure zein would exist in its rubbery state.

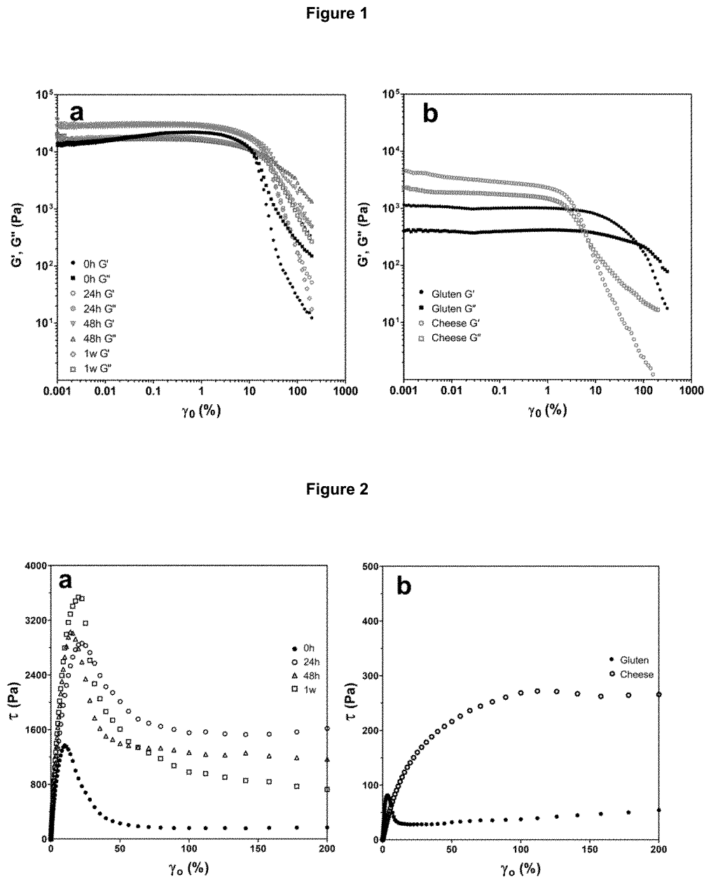

Amplitude Sweep—The storage and loss moduli (G′ and G″) of zein networks were obtained at different time points (0 h, 24 h, 48 h and 1 wk of storage) over increasing shear strain (γ=0.001% to 300%). This type of small amplitude rheological analysis probes the linear viscoelastic region (LVR) and can elucidate differences in material functionality. The LVR is characterized as the region of viscoelasticity, where the material produces constant values of storage and loss modulus within a specific range of applied strain. Zein samples were determined to exhibit linear viscoelasticity at low to mid strain rates throughout one week of storage (FIG. 1). At most time points, G′ values are greater than G″ in the LVR, indicating the existence of solid, gel-like characteristics. The exception to this trend are the 0 h samples (FIG. 1a) where G″ values remain slightly above G′ values throughout the applied strain rates until the material yields. This indicates that freshly formed zein networks demonstrate greater viscous properties, contrasting samples stored for 24 h or more. Storage for at least 24 h increases the G′ values above the relatively unchanging G″ values in the LVR, such that the networks do not have reduced viscous properties, but rather significantly increased elastic properties.

Another difference in behaviour was observed at the point where non-linear behaviour begins. This is characterized by the yield stress, which is defined here as the point where G′ and G″ crossover (tan δ=1). Due to the unique viscous behaviour that zein initially demonstrates (at 0 h), no crossover point was identified until reaching the 24 h time point. Still, a sharp decrease of G′ and G″ values at a higher strain rate (approximately 10%) is visually apparent in 0 h samples (FIG. 1a). The yield stress increases after reaching at least the 24 h storage time point, occurring at approximately 25% but not increasing further with additional storage time. This suggests that while it takes 24 hours for zein networks to fully form, there is no time dependence on network and bond formation beyond this. It is noted that the yield stress of zein was similar to that of cheese, which occurred at a strain rate of approximately 7%. However, the G′ and G″ values of zein samples are greater than those obtained for cheddar cheese.

The shear stress values (τ) were obtained simultaneously during amplitude sweeps at T=50° C. and have been plotted against shear strain (FIG. 2). These stress-strain curves highlight the brittle behaviour of zein networks, where very little applied strain compromises the material (FIG. 2b). Notably, the peak maximum occurs at approximately the same shear strain value, regardless of storage time, though the maximum shear stress reached for each sample increases with increasing storage. Gluten and cheese samples demonstrate significantly lower values, indicative of stronger, more ductile materials, although similar to zein, cheese displayed brittle characteristics.

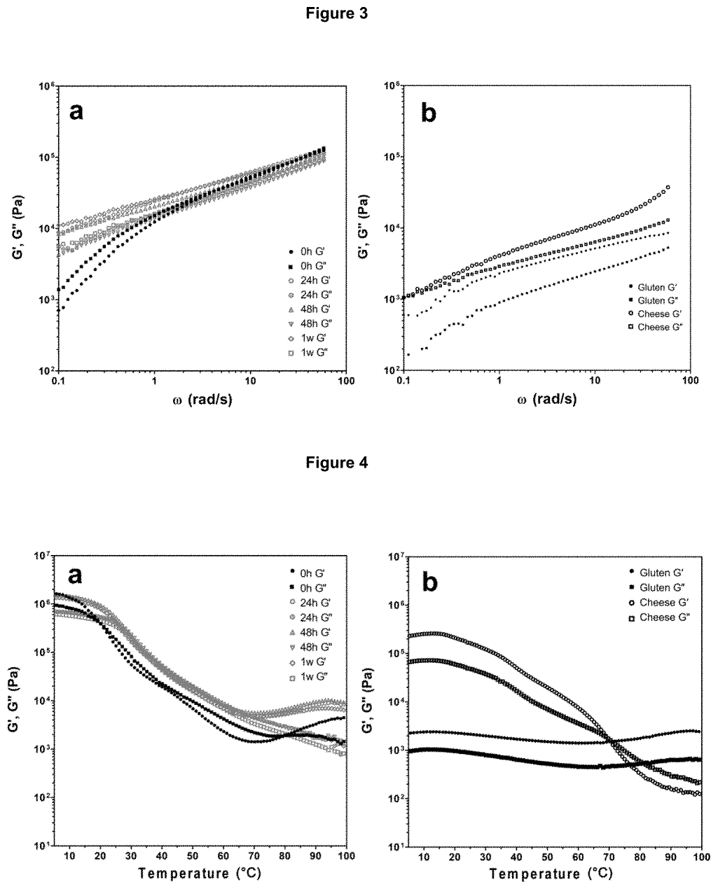

Frequency Sweep—The dependence of the samples on frequency was analyzed at γ=0.1%, which was determined to be within the LVR for all samples. Frequency sweeps provide information about changes in the viscoelastic properties of the polymer network, including the structure and the interactions between the polymers. Typically, a greater frequency dependence is observed in more fluid-like materials, while gels characteristically have little to no frequency dependence. Frequency sweeps performed at 50° C. (FIG. 3) revealed that there is a weak frequency dependence for zein networks at all time points. Accordingly, the slopes of the linear regions of each log(G′)-log(ω) plot (Table 2) are each less than 1. This behaviour matches that of a weak gel. Freshly formed zein networks have greater frequency dependence than zein samples at all other time points. This coincides with the fact that these 0 h samples are uniquely viscous, with G″>G′ throughout. The two values also approach each other as ω increases, behaviour reminiscent of a concentrated or entangled solution, where no covalent bonds exist to link a network. Zein networks then develop the behaviour of a weak gel after the 24 h time point, and differences between time points after this are almost indistinguishable.

There was a greater magnitude of difference between the G′ and G″ values of gluten networks than for zein networks. This points to the fact that gluten is more strongly bound together than zein networks. In contrast, cheese samples displayed greater frequency dependence (Table 2), which is logical given that cheeses exist in a partially melted state at 50° C. The frequency dependence of zein networks is similar to that of cheese samples, and may be made more similar by decreasing the hardness of zein networks.

TABLE 2
Slopes from log(G′)-log(ω) and log(G″)-log(ω) plots (frequency sweeps at 50° C. and γ = 0.01%)

| Zein | | | | | | | |
|---|---|---|---|---|---|---|---|
| Sample | | Slope | R² | Comparative Sample | | Slope | R² |
| 0 h | G′ | 0.76 ± 0.021 | 0.956 | Gluten Network | G′ | 0.41 ± 0.011 | 0.965 |
| | G″ | 0.65 ± 0.016 | 0.968 | | G″ | 0.51 ± 0.011 | 0.976 |
| 24 h | G′ | 0.42 ± 0.001 | 0.999 | | | | |
| | G″ | 0.48 ± 0.003 | 0.997 | | | | |
| 48h | G′ | 0.39 ± 0.001 | 0.999 | Cheddar Cheese | G′ | 0.50 ± 0.005 | 0.994 |
| | G″ | 0.46 ± 0.002 | 0.999 | | G″ | 0.38 ± 0.003 | 0.996 |
| 1 w | G′ | 0.37 ± 0.001 | 0.990 | | | | |
| | G″ | 0.44 ± 0.003 | 0.998 | | | | |

Temperature Sweeps are used to evaluate thermo-mechanical structural modifications and determine the temperatures at which these changes occur. Zein networks at all storage time points initially soften with increasing temperature (FIG. 4a), likely consequent of the weakening of non-covalent bonds at higher temperatures. This initial decrease is the steepest for 0 h samples, likely consequent of the weak structure formed by that point. Above 50° C., the G′ falls, until a crossover occurs at approximately 70° C. (80° C. for 0 h samples), after which the material becomes more elastic. There is a point in the range of 45° C. where G′ begins to approach G″ briefly, most easily seen in 0 h samples. Since zein's Tg was observed at approximately this temperature, it is likely that the conversion from glassy to rubbery domains causes a brief increase in the elastic modulus in the material. Similar to the findings from the amplitude and frequency sweeps, zein exhibits a more elastic response after reaching the 24 h time point. However, all zein networks demonstrate a greater viscous component in the range of approximately 20-70° C., where G′ values remain only slightly below G″ values. In addition, the difference between the points of maximum and minimum hardness (G′max and G″max vs. G′min and G″min) is extreme, where zein is essentially demonstrating melting behaviour in this range of temperatures.

Gluten networks remain elastic (with G′>G″) throughout the temperature range of 5-100° C., with minimal fluctuation in G′ and G″ values and magnitude of difference (FIG. 4b). As expected, cheese demonstrates melting behaviour over this range of temperatures, with G′>G″ initially, but crossing over to more viscous properties after approximately 70° C. While it has been mentioned previously that zein shares a number of rheological characteristics with cheese, the similar softening or melting behaviour with increasing temperature is an interesting result.

ATR FTIR analysis of the secondary structure of zein—The amide I and II bands, positioned at 1645 cm−1 and 1540 cm⁻¹, respectively, appear due to the vibration and stretching of amide bonds within the protein structure. The amide I band is predominantly caused by the stretching of the carbonyl (C═O) group, while the amide II band is primarily associated with the N—H bending and CN stretching vibrations. It has been well established that the amide I band is made up of numerous underlying bands, which can be used to determine the presence of different secondary structures. The values used here consist of: intermolecular β-sheets at 1610-1625 cm⁻¹, intramolecular β-sheets at 1630-1640 cm⁻¹, random coil at 1640-1648 cm⁻¹, α-helices at 1648-1658 cm⁻¹, β-turns at 1660-1668 cm⁻¹ and intramolecular β-sheets at 1670-1684 cm⁻¹.

Since it was determined that the rheological properties of zein change significantly from the 0 h to 24 h time points, but do not change significantly with additional time, only 0 h and 24 h samples were analyzed by FTIR. Through the deconvolution of the amide I band it was determined that zein networks contain primarily α-helical structures. Variation between the amide I spectra was found only in the region of 1640-1620 cm⁻¹. This corresponded to differences in the content of intermolecular and intermolecular β-sheets. These results suggest that zein networks initially form a greater extent of intermolecular β-sheets. However, there is a transition that occurs after 24 h where intramolecular β-sheets begin to predominate. This is perhaps a result of zein's high hydrophobicity. When water is introduced, zein quickly aggregates into a large mass to minimize the surface area exposed to the aqueous environment. This environment is therefore a driving force for intermolecular interactions due to the increasing protein-protein contact. With time, zein appears to slightly restructure, potentially caused by the preferred formation of non-covalent hydrophobic interactions that strengthen the network. It is therefore conceivable that the rearrangement to intramolecular β-sheets is preferred, and indicative of a stronger, more stable structure. This concept is also supported by the observed decrease in random structures present after 24 h.

### Conclusions

Zein networks demonstrate unique viscous properties when first formed, but a transition to a stronger, more elastic structure occurs after 24 h of storage. This is reflected in the secondary structure, with some conversion and reorganization taking place from intermolecular to intramolecular β-sheets during this time. The structure then stabilizes at this point, as increasing the storage time does not impact the rheological properties further. Zein exhibits some properties, e.g. softening at increased temperatures, that may make it useful in a simulated cheese product.

### EXAMPLE 2—ZEIN-BASED CHEESE PRODUCT

Plant-based cheese prototypes containing zein were analyzed with respect to texture, rheology, stretchability and moisture content. The prototypes produced contained zein at different percentages, as well as fats, starches and water. All ingredients and methods used were food grade and readily available. Samples were also prepared containing pea protein isolate (PPI) or wheat gluten for comparison purposes. Results were also compared to commercially available cheddar cheese and a plant-based cheddar-style alternative.

Materials—Maize zein from maize was obtained from Flo Chemical Corp., while the other ingredients used in formulation were purchased at a local supermarket. Cracker Barrel medium cheddar cheese (CC) and Daiya medium cheddar-style (farmhouse block) plant-based cheese (PBC) were used for comparative analysis and were also purchased at a local supermarket. From the nutrition label, the Cracker Barrel CC contained approximately 37% fat (23% saturated fat), 0% carbohydrates and 23% protein. The Daiya PBC contained approximately 21% fat (16% saturated fat), 25% carbohydrates and 3.6% protein. The main ingredients listed in the Daiya PBC were tapioca starch, coconut oil, canola oil and pea protein isolate.

Plant-Based Cheese Formulation—Plant-based cheese samples and controls were prepared containing 0% (control), 10%, 20%, or 30% zein. The starch and fat contents were decreased as the content of zein increased, but a ratio of 2:1 starch to fat was maintained in all formulations. The starch component comprised 33% corn starch and 67% tapioca starch. Tapioca starch was used based on its unique viscoelasticity upon gelatinization. Its ability to gelatinize into a stretchy malleable mass has made it a primary ingredient in most cheese alternatives currently on the market. Corn starch was added as the use of only tapioca starch was found to inhibit the ability of zein to form networks within the matrix. The fat component comprised of an unsaturated fat, high oleic sunflower oil (25%) and a saturated fat, coconut oil (75%). This combination was chosen to mimic the saturated and unsaturated fat content in cheeses. Comparative protein samples were also prepared containing PPI or wheat gluten, referred to further in this work as PPI cheese or gluten cheese. The compositions of all formulations are detailed in Table 3. Samples were prepared by combining ingredients and heating to approximately 80° C. on a stove top induction burner set to mid-low heat. The mixture was constantly stirred until reaching the desired temperature, approximately 5 min. Samples were placed in container moulds and stored under refrigeration for 24 hours before analysis.

TABLE 3
Plant-based cheese sample compositions

| | 0% | 10% | 20% | 30% | Gluten | PPI |
|---|---|---|---|---|---|---|
| Component | Zein | Zein | Zein | Zein | Cheese | Cheese |
| Zein | — | 10% | 20% | 30% | — | — |
| Fat Component | 11.6% | 8.2% | 4.8% | 1.5% | 4.8% | 4.8% |
| Starch Component | 22.7% | 16.1% | 9.5% | 2.8% | 9.5% | 9.5% |
| Xanthan Gum | 0.7% | 0.7% | 0.7% | 0.7% | 0.7% | 0.7% |
| Water | 65% | 65% | 65% | 65% | 65% | 65% |
| Gluten | — | — | — | — | 20% | — |
| PPI | — | — | — | — | — | 20% |

Small Amplitude Oscillatory Dynamic Rheology—Shear oscillatory experiments were performed with a rotational rheometer (MCR 302, Anton Paar, Graz, Austria) fixed with parallel plate geometries (20 mm diameter). The geometries were fixed with adhesive 600 grit sandpaper to minimize slip during measurements. Cheese samples, were placed onto the lower plate and compressed between the plates with an axial force not exceeding 2N to avoid error from overloading. Samples were loaded onto the plates with temperature control by Peltier units located in the lower plate and the hood of the rheometer. The exposed edges of the samples were coated with mineral oil to prevent drying during testing. RheoCompass software and firmware (Anton Paar, Graz, Austria) provided the storage modulus (G′), loss modulus (G″), and shear stress (τ) values used for analysis. Temperature sweeps were performed where the temperature was increased from 5° C. to 100° C., the shear strain was constant at γ=0.01% and the angular frequency was constant at ω=3 rad/s. Amplitude sweeps were performed on CC, PBC and 30% zein samples, where the shear strain was increased from γ=0.001% to γ=200%, while the angular frequency was constant at ω=3 rad/s and the temperature was constant at 50° C. This temperature was chosen to ensure that zein was above its glass transition temperature (˜45-50° C.), in addition to the specific interest in the properties of cheese samples at elevated temperatures.

Texture Profile Analysis—A Model TA.XT2 texture analyzer (Stable Micro Systems, Texture Technologies Corp., Scarsdale, N.Y.) affixed with a 30 kg load cell was used to perform texture profile analysis (TPA) on the different gel samples. Samples were prepared by cutting 15 mm diameter cylindrical sections from the gels using a corer. Samples were analyzed on a modified platform with temperature control via attached water bath. Analysis took place at both 5° C. and 50° C., and temperature was ensured as the water bath was set to the correct temperature and allowed to circulate for 30 minutes to ensure the platform had reached the desired temperature. Samples were also covered and stored in an incubator set to 50° C. prior to analysis. Samples were analyzed using a two-part compression between parallel plates at a fixed speed of 1.5 mm/s to 75% of the height of the sample. The hardness was reported as peak maximum force (in g) upon first compression. The other parameters reported—gumminess, chewiness, and springiness—were defined as follows:

$$Gumminess = Hardness \times \frac{Area under 2 nd compression peak}{Area under 1 st compression peak} \qquad 1 )$$

$$Chewiness = Gumminess \times \frac{Time to reach peak during 2 nd compression}{Time to reach peak during 1 st compression} \qquad 2 )$$

$$Springiness = \frac{Time to reach peak during 2 nd compression}{Time to reach peak during 1 st compression} \qquad 3 )$$

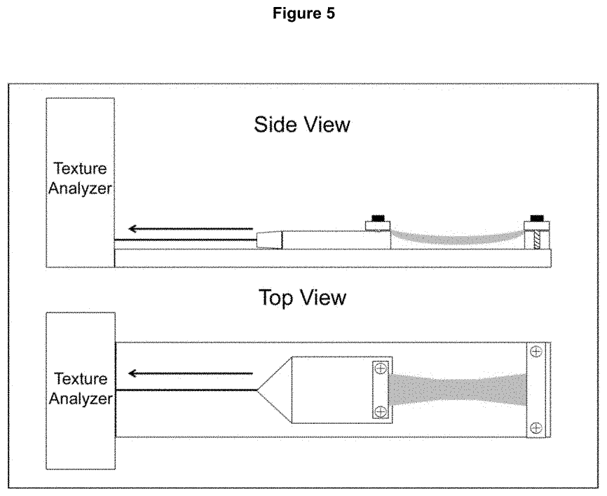

Cheese Stretchability—The stretchability or extensibility of plant-based and conventional cheeses was analyzed using a modified sliding friction rig set up (FIG. 5) affixed to a TA.XT2 texture analyzer (Stable Micro Systems, Texture Technologies Corp.) with a 30 kg load cell. The friction rig was modified such that cheese samples could be clamped to the top of the sled and at the end of the attachment base. An additional surface was added at the end of the attachment base to raise the clamp to the same height as the sled (10 mm) such that the cheese samples could be clamped to a flat surface. Clamps at either end were 30 mm in width, thereby allowing for the soft clamping of a larger sample surface area and preventing tearing by pinching. Adhesive 600 grit sandpaper was fixed to the upper and lower surfaces of both clamps to minimize slip. Samples were prepared by cutting and fitting the cheeses into a plastic form such that samples were 40 mm in length 30 mm in width and 5 mm tall. Samples were heated in the plastic form in a microwave oven to 65° C. and tested immediately after heating to ensure testing occurred at the desired elevated temperature. During testing, the sled was pulled at a constant speed of 2.5 mm/s over a total distance of 125 mm and the force required to maintain the constant speed was recorded. The base of the attachment was coated with a thin layer of mineral oil to minimize friction during pulling. The force required to pull the sled along the base without any sample was also recorded as the baseline force and was subtracted from the values. The stretching profiles were plotted as a function of force required against the distance travelled in order to visualize the stretching behaviour. The values of maximum force required, the distance at the time of maximum force, as well as the distance at the time of break were all recorded from the collected data for each sample.

Moisture Content—Approximately 4 g of each zein cheese, CC and PBC samples were crumbled into small pieces and weighed in aluminum weigh boats. The samples were placed into a Thermo Scientific Heratherm oven set to 100° C. and left for 24 hours. After the time had elapsed the dried samples were weighed again. Moisture content was expressed as percentage of the weight of water lost over the total initial weight.

Statistical Analysis—GraphPad Prism 5.0 (GraphPad Software, San Diego, Calif., USA) was used for statistical analysis. One-way ANOVA, with a Tukey's multiple comparison test, was performed on the stretch/extensibility and moisture content data for each sample type. A One-way ANOVA and Tukey post-test were also performed on the TPA parameters for each sample type. The level of significance for each was chosen as p<0.05.

### Results

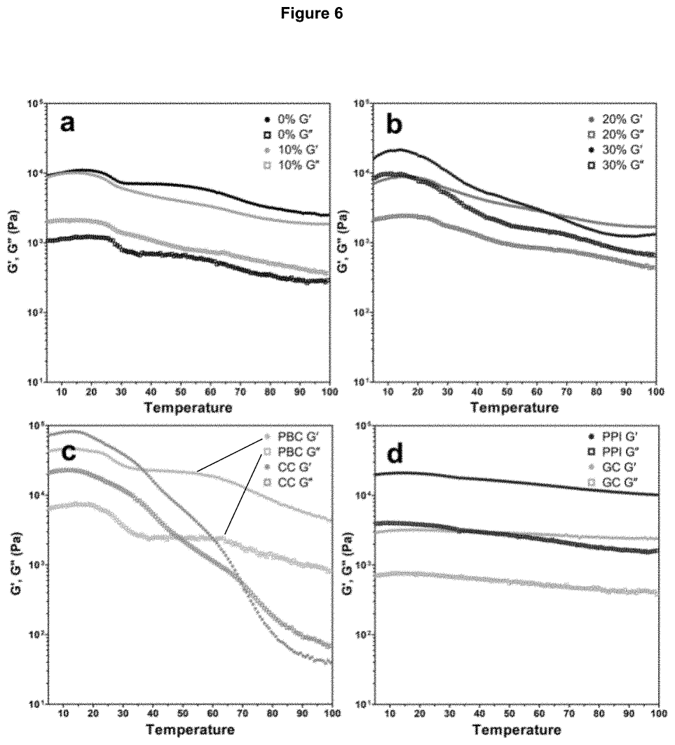

Rheological Behaviour—Temperature sweeps evaluated the melting ability of the cheese samples, specifically evaluating the ability of the samples to soften and flow as temperature was increased from 5° C. to 100° C. The melting profiles of each sample were plotted and revealed distinct differences in melting behaviour (FIG. 6). Samples containing primarily starch and fat (0% and 10% zein) remained highly elastic and only softened slightly, evident by the gradual slope of G′ and G″ with increasing temperature (FIG. 6a). Networks that contained increasing amounts of zein (20% and 30%) began to demonstrate more significant melting, as the slopes of G′ and G″ values decreased more drastically, particularly in 30% zein samples (FIG. 6b). The 30% zein samples also displayed increasing viscous properties (G′ only slightly greater than G″), indicative of a greater ability to flow at elevated temperatures. Similar to casein networks in conventional cheeses, it is expected that the softening of zein is largely consequent of the weakening of non-covalent bonds at higher temperatures. In this way, zein is well suited to the application plant-based cheeses, where interactions weaken within the network but are not completely lost, allowing the material to remain somewhat elastic at high temperatures. The melting or softening observed in 30% zein samples is notable, as these samples contained minimal amounts of solid fat, leading to the conclusion that a significant amount of fat is not required to achieve the desired melting behaviour in zein-based cheeses. While the melting profile does not completely mirror that of CC, it is significantly more comparable than the PBC analyzed. PBC samples were exceedingly elastic and behaved similarly to the 0% zein control (FIG. 6c). This makes sense, as the composition of the PBC was also primarily starch and fat. Some softening was observed in PPI and gluten cheese samples, however softening was minimal even when compared to 0% controls (FIG. 6d). The lack of melting observed in these samples appears to be as a result of the covalent bonds within a gluten network (which do not weaken with increasing temperature), and the relative inability of PPI to form a network in this environment.

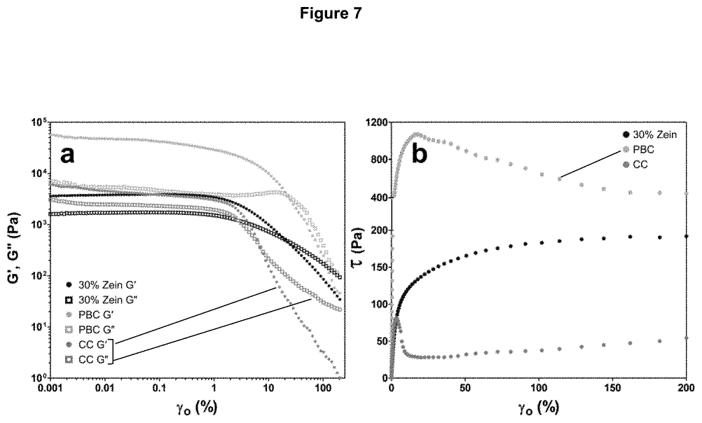

Amplitude sweeps were performed at 50° C., which was chosen to examine the rheological properties (linear viscoelastic region and the critical or yield strain value) of the samples when the fat content was sufficiently melted. This ensured that the properties analyzed could be primarily attributed to the protein content of the samples. Only CC, PBC and 30% zein samples were evaluated due to the similarities between 30% zein and CC samples previously observed in temperature sweeps. The logarithmic plots of G′ and G″ values vs. increasing y made it apparent that CC samples reach their point of critical strain slightly before the PBC and 30% zein samples (FIG. 7a). Aside from this difference, CC and 30% samples display very similar behaviour in their respective linear viscoelastic regions. PBC samples are quite different, displaying greater elasticity or solid characteristics, likely due to the high starch content. When τ values were plotted against increasing shear strain in stress vs. strain curves, information about the yield strength and brittleness of the material was obtained (FIG. 7b). Here, it was observed that CC samples demonstrate behaviour of a weak and brittle material. While 30% zein samples shared a similar overall strength, they were not as brittle as CC samples. The PBC samples displayed drastically different behaviour in terms of overall strength. While there are clearly some rheological differences between the CC and 30% zein samples, the plant-based cheese samples containing zein behaved in a fashion more similar to CC than to the PBC samples.

Texture Profile Analysis (TPA)—TPA involves a double compression of the sample that mimics the action of chewing. This makes the technique highly reliable when it comes to mechanically determining values for different sensory properties of solid or semi-solid foods. In this work, the values for hardness, springiness, chewiness, and gumminess for all samples were compared. Since the texture of cheese is relevant at both low and high temperatures, testing at both 5° C. and 50° C. allowed for direct comparison of both low and high temperature functionality of all samples.

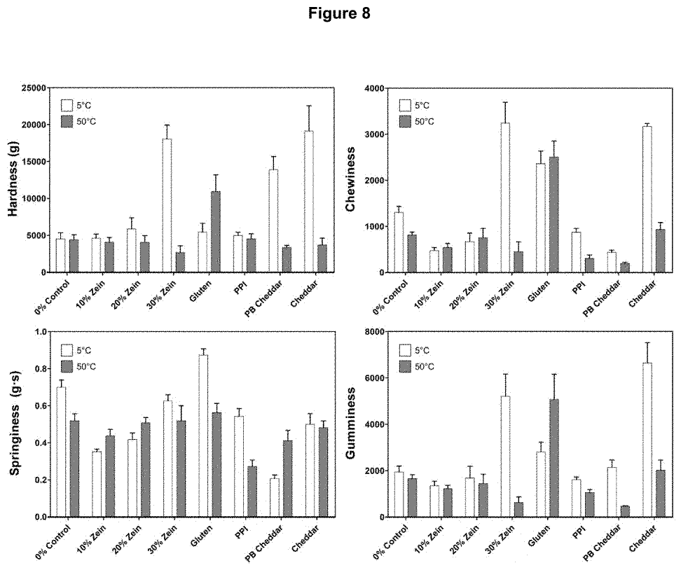

The results obtained showed that the hardness, chewiness and gumminess of 0%, 10% and 20% zein cheese samples remained relatively unchanged between the two temperatures analyzed (FIG. 8). However, the 30% zein cheeses displayed highly similar behaviour to CC in each of the textural parameters analyzed, both in terms of magnitude of values and relative change in values with the increase in temperature. This included high hardness, chewiness and gumminess at 5° C., followed by a significant decrease in each at 50° C. The decrease in each of these parameters is consequent both of the melting of solid fat at higher temperatures, and the previously observed softening of zein or casein networks. The springiness of both 30% zein and CC samples was relatively unchanged with the increase in temperature. This suggests that the protein content is largely responsible for the springiness of the cheeses, and that the weakening of non-covalent interactions within the protein networks does not impact the springiness of the overall product. Interestingly, while the hardness of PBC did decrease with the greater temperature similar to CC samples, there were no further similarities. In fact, the PBC samples were notably lacking chewiness and gumminess when compared to CC samples. It is expected that this is caused by the fact that the PBC did not contain a protein network, but rather relied on starch and solid fat for texture. From the results of this work, it can be said that the presence of a non-covalently linked protein network is associated with a cheese-like texture.

The analysis of PPI and gluten cheese samples clearly demonstrated that the cheese-like properties are unique to zein and cannot be re-created with different plant-based proteins. PPI cheese samples displayed textural properties largely similar to 0% zein controls. Gluten cheese samples displayed detrimentally high levels of hardness, chewiness and gumminess at both temperatures. In addition, the values of these parameters increased at 50° C., the opposite of what is desirable when cheese is melting. These drastically different textural properties were observed despite the fact that gluten is also a prolamin and shares many properties with zein.

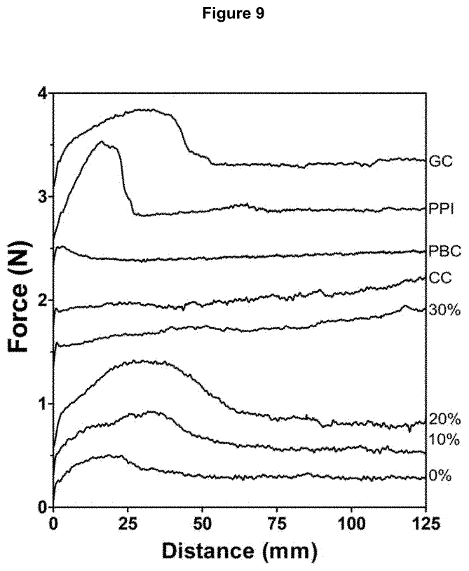

Cheese Extensibility—The textural and rheological results presented thus far have highlighted the highly similar behaviour of 30% zein formulations with CC. The ability of cheese to stretch at high temperatures is a factor in cheddar cheese acceptability. Many studies have addressed methods to analyze this property, and identified that results depend on rate of heating, method of heating, and rate of application of stress. To control for this variation, all samples were analyzed using microwave heating to approximately 65° C., and stretched at a rate of 2.5 mm/s. The stretch or extensibility was evaluated through measurement of force required to pull the sample, as well as the distance required to break the cheese sample. Differences in the extensibility of the samples are visualized in the different profiles obtained as stretching took place (FIG. 9). Both the 30% and the CC samples did not break throughout the entire pulled length, visualized as a straight line with a steadily increasing slope. This observed stretchability of 30% zein cheese samples adds to the list of its cheese-like properties. This is particularly evident when noting the fact that all other samples tore during the stretch distance. As such, a peak of maximum force was observed in the other samples, followed by a decline in force after the sample had torn in two. The peak observed for 0%, 10% and 20% zein samples demonstrates a steady increase and decline as the samples tore gradually. In contrast, gluten cheese and PPI cheese samples demonstrate a steady increase in force, but a sharp decline after tearing abruptly. This breaking resulted in an immediate reduction of force required to pull the sled. The PBC was the least extensible of all samples, tearing almost immediately after the sled was in motion. In addition, minimal force was required to tear the sample, resulting in only a minor peak early on in the pulling distance.

The values obtained for distance to break were recorded and statistically significant differences were noted (Table 4). As the 30% zein and CC samples did not break, no value for distance to break was recorded and the maximum force recorded occurred at the end of the 125 mm distance. The 10%, 20% and gluten cheese samples stretched the furthest of the remaining samples. The continually increasing distance to break as the zein content was increased from 0% to 30% further proves that zein is responsible for the extensibility of plant-based zein cheeses. Despite the slight extensibility of gluten cheese samples, the fact that samples broke so suddenly is not indicative of gluten functioning well in a cheese-like material. Interestingly, the PBC product analyzed displayed the shortest distance to break, statistically different than all other analyzed samples. This result emphasizes the fact that currently available products lack cheese-like properties.

The values of maximum force required were also recorded, however the maximum recorded force was relatively low for all samples, and as such few statistically significant differences were seen (Table 4). It should be noted that the maximum force was taken as the maximum recorded force minus the minimum recorded force, as the minimum represented the force required to pull the sled along the surface of the attachment due to friction. The lack of significance between the samples suggests that the maximum force was not a sensitive parameter in this analysis. However, PPI samples had the greatest maximum required force, indicating a more rigid structure, while the PBC required the lowest amount of force to break, and as such was the most fragile sample. It was also noted that 30% zein and CC samples registered only a moderate maximum force indicating that, in addition to stretching the furthest, they did so with ease. The superior stretching behaviour of 30% zein and CC signifies that zein provides a similar functionality to that provided by casein in conventional cheese. Similar to casein, zein networks soften with increasing temperature, likely resultant of weakening non-covalent interactions. The extensibility of zein and casein is indicative that the bonds are simply weakened but not lost.

TABLE 4
Extensibility properties of conventional cheese and plant-based
cheese samples

| Sample | Distance to Break (mm) | Max Force (N) |
|---|---|---|
| 0% Zein control | 32.08 ± 1.36^{a} | 0.561 ± 0.02^{ab} |
| 10% Zein | 49.05 ± 2.15^{bc} | 0.747 ± 0.04^{bc} |
| 20% Zein | 56.64 ± 4.14^{b} | 0.793 ± 0.09^{bc} |
| 30% Zein | >125* | 0.588 ± 0.05^{ab} |
| Gluten | 45.06 ± 2.90^{c} | 0.664 ± 0.05^{bc} |
| PPI | 25.30 ± 2.06^{a} | 0.919 ± 0.1^{c} |
| PB Cheddar | 7.62 ± 1.45^{d} | 0.238 ± 0.07^{a} |
| Cheddar Cheese | >125* | 0.479 ± 0.1^{ab} |

Values with the same superscript letter within the same column are not statistically different
*Samples did not break over the distance tested

Moisture Content—The moisture content of the different zein cheese samples, CC, and PBC was determined. This analysis was deemed to be significant as increasing the moisture content has been previously shown to negatively impact the physical properties of low fat cheeses. Given the low fat content in the zein cheese samples, particularly 30% zein samples, this was potentially a contributing factor to the physical properties. The results made it evident that all zein cheese samples contained a significantly greater content of moisture than CC and PBC samples (Table 5). In particular, 30% zein samples contained over 60% moisture, while CC samples contained less than 40%. This result highlights the fact that 30% zein cheese samples showed highly cheese-like functionality despite the prominent difference in moisture content. An increased presence of water in cheeses may cause unfavourable softening due to plasticization of the protein network. However, for zein cheeses, it is likely that the high content of water does not cause negative physical consequences because the plasticization that comes with increasing amounts of water is desirable in zein networks. This is advantageous in that not only do the zein products provide desirable cheese-like physical properties, but do so with an increased moisture content and subsequent reduced caloric and fat content compared to conventional cheeses and plant-based cheese currently on the market. It has noted, however, that low fat mozzarella and cheddar cheeses do not show adequate melting and stretching behavior due to the cheeses become too dehydrated when heated in an oven. This occurs in the presence of insufficient fat, therefore some content of free oil upon melting is still required in the formulation to coat the surface and act as a moisture bar.

TABLE 5
Moisture content of cheese and plant-based cheese samples

| Sample | Moisture Content (%) |
|---|---|
| 0% Control | 68.76 ± 0.20^{a} |
| 10% Zein | 64.18 ± 0.52^{b} |
| 20% Zein | 61.88 ± 0.18^{c} |
| 30% Zein | 62.89 ± 0.17^{c} |
| PB Cheddar | 47.66 ± 0.35^{d} |
| Cheddar Cheese | 38.26 ± 0.16^{e} |

Values with the same superscript letter are not statistically different.

Overall, the zein-based cheese prototypes analyzed here provide a product having cheese-like properties that render it a suitable cheese substitute.

### EXAMPLE 3—PROLAMIN CHEESE PRODUCTS COMPRISING PLASTICIZER

Cheese products were made comprising the following components: zein/protein, plasticizer, fat component, thickening and/or gelling agents, and water. Each of these components was systematically examined through the modification and removal of other components. The components of the cheese products are generally set out in Table 6.

TABLE 6

| Component | Subcomponent | Percentage of Composition |
|---|---|---|
| Zein/Protein | | 0-25% |
| Plasticizer and/or Acid | | 0-5% |
| Fat Component | | 5-25% |
| Thickening and/ | Emulsifying | 0-5% |
| or Gelling | Thickening | 0-10% |
| | Gelling | 0-10% |
| | Filler | 5-10% |
| Water | | 45-60% |

Zein Cheese Production—Plant-based cheese samples and controls were prepared containing zein, a fat component, a thickening and/or gelling component and water. The exact compositions of all investigated formulations are detailed in each section below. Water was weighed and added to a Thermomix (Vowerk, Wuppertal, Germany). The thickening and/or gelling ingredients were dry blended and added to the Thermomix on top of the water, and then mixed at speed 4 for 2 minutes at 40° C. The mixture was then heated to 90° C. and mixed at speed 2.5 for 7 minutes. The thickening and/or gelling component was then allowed to cool until reaching ˜45° C., while constantly stirring. The fat component (melted and at ˜45° C.) was then added along with zein and the plasticizer. The Thermomix was then set to 40° C. and the contents were mixed for 5 minutes, starting at speed 0.5 for the first minute, increasing to speed 2 for 2 minutes, and finally increasing to speed 3 for the final 2 minutes. Samples were placed in container moulds and stored under refrigeration for 24 hours before analysis.

Rheology: Small amplitude oscillatory dynamic rheology—Shear oscillatory experiments were performed with a rotational rheometer (MCR 302, Anton Paar, Graz, Austria) fixed with parallel plate geometries (20 mm diameter). The geometries were fixed with adhesive 600 grit sandpaper to minimize slip during measurements. Cheese samples, were placed onto the lower plate and compressed between the plates, with temperature control by Peltier units located in the lower plate and the hood of the rheometer. RheoCompass software and firmware (Anton Paar, Graz, Austria) provided the storage modulus (G′), loss modulus (G″), and shear stress (τ) values used for analysis. Temperature sweeps were performed first, where the temperature was increased from 5 to 100° C., the shear strain was constant at γ=0.01% and the angular frequency was constant at ω=3 rad/s. Temperature sweeps evaluated the melting ability of the cheese samples, specifically evaluating the ability of the samples to soften and flow as temperature was increased from 5° C. to 100° C.

Viscosity—Dynamic viscosity measurements were performed with a rotational rheometer (MCR 302, Anton Paar, Graz, Austria) equipped with a concentric cylinder and a vane geometry. These tests probed the viscosity of the thickening and/or gelling component, allowing for the establishment of a relationship between the composition and the ability of this base to support the formation of a zein network. The conditions were controlled to mimic the conditions within the thermomix during cheese production. The stages for the measurement varied in temperature, but maintained a constant speed of 200 rpm throughout. The temperature stages were as follows:
1. 40° C. to 90° C. at 0.2° C./s
2. 90° C. hold for 7 minutes
3. 90° C. to 40° C. at 0.2° C./s
4. 40° C. hold for 5 minutes

Texture Profile Analysis (TPA)—A Model TA.XT2 texture analyzer (Stable Micro Systems, Texture Technologies Corp., Surrey, UK) affixed with a 30 kg load cell was used to perform texture profile analysis (TPA) on the different cheese samples. Samples were prepared by cutting 15 mm diameter cylindrical sections from the gels using a corer. Samples were analyzed on a modified platform with temperature control via attached water bath. Analysis took place at both 5° C. and 50° C., and temperature was ensured as the water bath was set to the correct temperature and allowed to circulate for 30 minutes to ensure the platform had reached the desired temperature. Samples were also covered and stored in an incubator set to 50° C. prior to analysis. Analysis was performed in triplicate. Samples were analyzed using a two-part compression between parallel plates at a fixed speed of 1.5 mm/s to 75% of the height of the sample. The hardness was reported as peak maximum force (in g) upon first compression. The other parameters reported—gumminess, chewiness, and springiness—are defined above.

Three Point Bend—A Model TA.XT2 texture analyzer (Stable Micro Systems, Texture Technologies Corp., Scarsdale, N.Y.), was used to measure the hardness and flexibility of zein samples. A three-point bend rig was set to a 30 mm gap width, and a 30 kg load cell. Samples were formed in rectangular moulds to produce pieces 40 mm long, 20 mm wide and 5 mm thick. The zein was stored in the moulds at 40° C. for 24 hours before analysis. The probe moved at a test speed of 3 mm/s over a distance of 15 mm, and the applied force increased to maintain this speed. The magnitude of force necessary to bend the samples was recorded as an indicator of sample hardness. Plotting force against distance travelled allowed for interpretation of sample flexibility, where the existence of a peak was indicative of brittleness or fracture, relative to a smooth curve that indicated the sample was flexible and ductile.

Cheese Stretchability—The stretchability or extensibility of plant-based and conventional cheeses was analyzed using a modified sliding friction rig set up (FIG. 5) affixed to a TA.XT2 texture analyzer (Stable Micro Systems, Texture Technologies Corp.) with a 30 kg load cell as previously described.

Stretchability, or the lack there of, was also established by a simple fork test. Cheese samples were heated to a temperature of approx. 80° C., then allowed to cool to approximately 60° C. A fork was used to pull the cheese upward and the ability of the material to stretch, form strands of stretched material, was evaluated qualitatively.

Statistical Analysis—GraphPad Prism 5.0 (GraphPad Software, San Diego, Calif., USA) was used for statistical analysis. One-way ANOVA was performed on the stretch/extensibility and moisture content data for each sample type presented in this paper. A One-way ANOVA was also performed on the TPA parameters for each sample type, where the same sample at different temperatures and different samples at the same temperature were analyzed separately. The level of significance each was chosen as p<0.05.

Materials—Materials used are identified in Table 7.

TABLE 7

| Material | Details/Source |
|---|---|
| Protein | Zein (Flo Chemical Corp.) |
| | Pea Protein Isolate (MyProtein) |
| | Pea Protein Concentrate (Vitessence Pulse |
| | 1803, Ingredion) |
| | Gluten (Generic) |
| Commercial Cheese | Medium Cheddar (Cracker Barrel) |
| | Mozzarella (Cracker Barrel) |
| Commercial Plant Based | Cheddar-Style Block (Daiya) |
| Cheese | Cheddar Flavour Slices (Violife) |
| Fats/Oils | Cocoa Butter (Ecoideas) |
| | Canola Oil (Generic) |
| | Coconut Oil, Refined (Spectrum) |
| | Coconut Oil, Refined (Nutiva) |
| | Coconut Oil, Unrefined (Generic) |
| Acids | Malic Acid (Texturestar) |
| | Citric Acid (Texturestar) |
| | Tartaric Acid (CellarScience) |
| | Lactic Acid (Modernist Pantry) |
| | Glacial Acetic Acid (Sigma) |
| Starches | Potato Starch (Precisa 604, Ingredion) |
| | Potato Starch (Generic) |
| | Tapioca Starch (Homecraft Express 390, |
| | Ingredion) |
| | Tapioca Starch (Generic) |
| | Com Starch (Novation 4300, Ingredion) |
| | Com Starch (Novation 4600, Ingredion) |
| | Com Starch (N-Creamer 2000, Ingredion) |
| | Com Starch (Instant Clearjel, Ingredion) |
| Gums | Agar (Seaweed Solution) |
| | Guar Gum (Generic) |
| | Locust Bean Gum (Texturestar) |
| | Konjac Gum (Modernist Pantry) |
| | Konjac/Agar blend (Ticagel Bind 55-AK, TIC) |
| | Konjac/Xanthan Blend (Tigagel Bind KX, TIC) |
| | Carrageenan and Locust Bean Gum (Ticagel |
| | 500 FL, TIC) |
| | Gellan Gum (Ticagel Gellan HS, TIC) |
| | K-Carrageenan (Landor) |
| | Xanthan Gum |
| Other | LMA Pectin/Tricalcium Phosphate blend |
| | (Modernist Pantry) |
| | Inulin (Texturestar) |
| | Microcrystalline cellulose (Modernist Pantry) |
| | Carboxymethyl cellulose (Modernist Pantry) |

(Materials designated as generic were purchased at a local supermarket)

The functionality of plant-based cheese products was established based on the following criteria: texture, meltability and stretchability. The texture aspect is evaluated by the ability of cheese to hold their shape at fridge temperatures and be cut or sliced. Texture profile analysis was also performed to provide a quantitative insight into the texture of the materials. While TPA can be used to quantify a number of textural properties, only the hardness of the materials is reported. The melting aspect is separated into two aspects, the first being the rheological melting profile that exhibits storage (G′) and loss (G″) modulus values that decrease by a magnitude of more than 10³ over a temperature range of 5 to 100° C. Additionally, the magnitude of difference between these values decreases as the temperature increases, such that the tan δ value (G″/G′) remains close to or greater than 1. Additionally, meltability was evaluated by the loss of shape at elevated temperatures (>60° C.) such that the product of cylindrical shape measuring 10 mm tall and 20 mm in diameter increases in diameter by up to or greater than 2×. The stretching aspect is evaluated by the ability of a product to extend up to, or greater than, 5× its original length without breaking. Stretching is considered optimal when the product can extend up to, or greater than, 100× its original length without breaking. The existence of stretching behaviour is considered a qualitative aspect throughout this document, however a stretching rig affixed to a texture analyzer as described above was also used to provide a visual or quantitative aspect where needed. This stretching rig was not used to establish the presence or absence of stretching behaviour, but rather to describe the stretching behaviour in more detail. A summary of these criteria can be found in Table 8.

TABLE 8
Functionality Criteria Definitions

| Criteria | Description |
|---|---|
| Sliceable | Refrigerated samples can be sliced while other- |
| | wise maintaining shape and without fracturing. |
| TPA Hardness at | Recorded as the maximum force recorded during |
| 5° C. and 50° C. | the first compression of a TPA double compres- |
| | sion cycle, taken at different temperatures to |
| | quantify any softening that occurs. |
| Rheological Melt | G′ and G″ values decrease significantly with |
| | increasing temperature, and the tan δ approaches |
| | or is greater than 1. |
| Loss of Shape | Samples measuring 10 mm (height) by 20 mm |
| | (diameter) will increase by up to or greater than |
| | 2× in diameter when heated over 60° C. |
| Stretch | Melted samples (at or above >50° C.) exhibit |
| | stretch up to or greater than 5 × initial height |
| | determined by pulling with a fork, or by separat- |
| | ing pieces using a specially designed stretching |
| | attachment with a texture analyzer. |

Cheese Products with different proteins—The functionality of cheese products made with different proteins (zein, gluten and pea protein isolate (PPI)) were compared, and the results are summarized in Table 9. Each cheese product comprised about 15-20% of the selected protein, 20-25% fat and 5-15% gelling/thickening agent, 5-10% filler, each by weight of the product, and water.

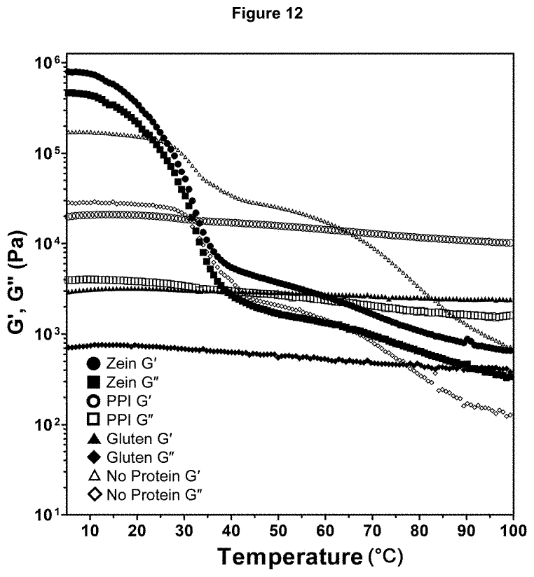

The rheological melt profile (FIG. 12) was observed to depend significantly on the presence of zein. The use of gluten or PPI resulted in a complete loss of melting, where cheeses did not demonstrate a decrease in G′ and G″ values. While samples without any protein did demonstrate behaviour representative of melting, the magnitude of difference between G′ and G″ values was much greater, such that the tan δ value (G″/G′) would be much lower relative to that of the zein samples.

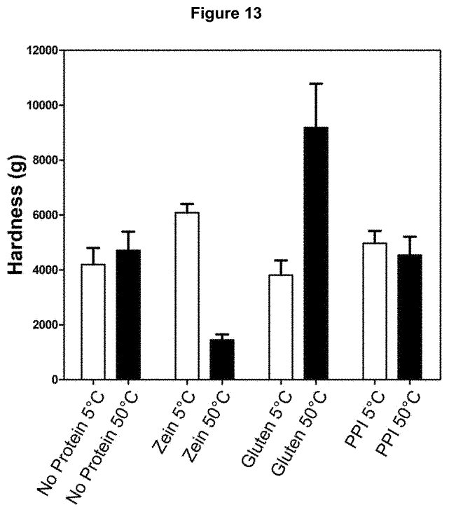

Regarding hardness, cheeses prepared with gluten were able to be sliced, similar to zein, however, they also increased in hardness at increasing temperature, which is notably not cheese-like behaviour (FIG. 13). Gluten products also did not lose their shape when heated. Products produced with PPI and those containing no protein did not soften at increased temperatures, however some loss of shape was possible with these products, although to a lesser degree than desirable.

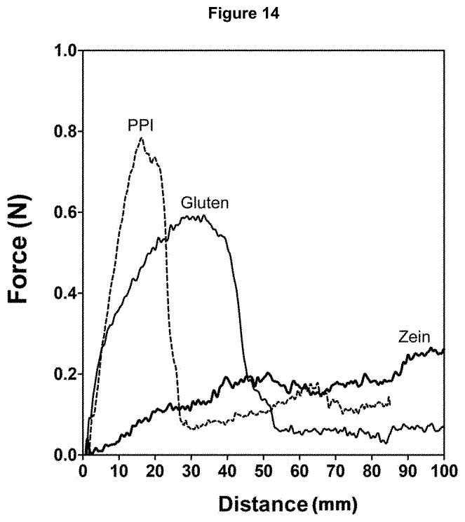

The stretch functionality of the cheese product was impacted the most significantly by altering the protein content of the product. Gluten and PPI samples broke well before the zein samples (FIG. 14). The gluten and PPI samples also required more force to stretch, indicating overall more elastic and gel-like behaviour. Samples containing no protein are not shown as they did not produce a significant signal during stretching, representative of a lack of stretch function.

The results are summarized in Table 9.

TABLE 9

| | Functionality | | | | |
|---|---|---|---|---|---|
| | | | Melt | Loss of | |
| Protein Source | Hardness | Sliceable | Profile | Shape | Stretch |
| Zein | √ | √ | √ | √ | √ |
| Gluten | X | √ | X | X | X |
| Pea Protein Isolate | X | X | X | √ | X |
| No Protein | X | √ | X | √ | X |

Check marks indicate that the protein exhibited the listed functionality, X’s indicate that the protein did not exhibit the listed functionality to a sufficient extent required.

Comparison of Zein Cheese to Commercial Cheeses: Zein cheeses were compared to commonplace commercial products. As standard dairy products, cheddar and mozzarella cheeses were included. As standard plant-based products, Daiya and Violife cheddar-style products were included. The approximate composition of each cheese is set out Table 10.

TABLE 10
Approximate Sample Composition

| | Zein Cheese | Daiya* | Violife* | Cheddar* | Mozzarella* |
|---|---|---|---|---|---|
| Fat | 20-25% | 21% | 23% | 37% | 27% |
| Protein | 10-30% | 3.6% | 0% | 23% | 23% |
| Carbohydrate | 5-15 | 25% | 20% | 0% | 0% |

*Composition of commercial products obtained from nutritional information

The zein cheeses comprised coconut oil as the fat, starch and AK gum as thickening agents, inulin as a filler, malic, tartaric or citric acid as a plasticizer and the balance was water.

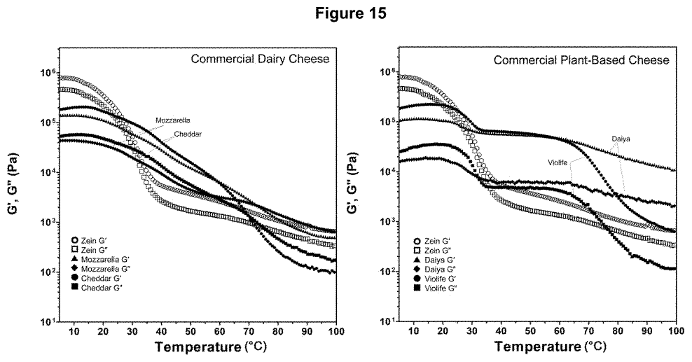

The rheological melting profile of zein cheese more closely mirrored that of conventional dairy cheeses than the two different plant-based (PB) cheeses analyzed (FIG. 15). This included the steep decrease in G′ and G″ values over the temperature range, in addition to the fact that the two values remained close to one another throughout the range (tan δ values closer to 1). Both plant-based samples demonstrated much more elastic behaviour, with G′ values much greater than G″ throughout.

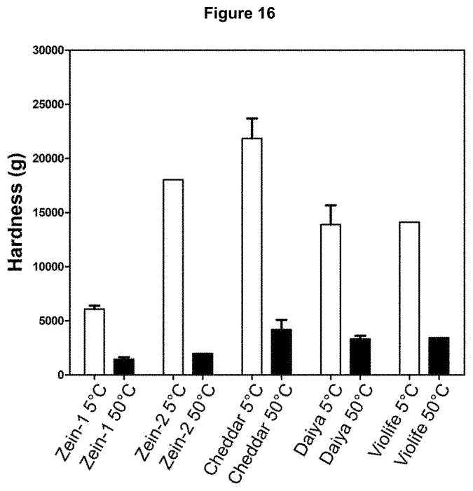

Hardness by TPA looked at 2 different zein formulations. The first (Zein-1) contained only 15% zein and did not demonstrate the same hardness as the other samples, although the decrease in hardness at greater temperatures was still evident. The second (Zein-2) contained 30% zein and demonstrated hardness values similar to the commercial products, including conventional cheddar cheese as shown in FIG. 16. The two commercial plant-based products did demonstrate slightly reduced maximum hardness at low temperatures, relative to cheddar, however they did decrease in hardness at greater temperatures.

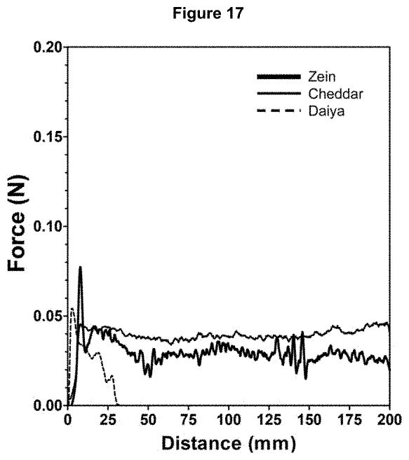

Stretch was the most remarkable aspect, where zein samples were able to stretch through an entire 200 mm distance, just like the cheddar cheese sample as shown in FIG. 17. In contrast, the plant based sample analyzed did not stretch more than 30 mm before breaking entirely.

Each of cheese samples possessed the functionality of being sliceable. After slicing, the two separate pieces of each cheese easily held their shape. Thus, zein provides a cheese product that is sliceable and maintains shape.

TABLE 11
Summary of Functionality of Zein product vs. Commercial products

| | Functionality | | | | |
|---|---|---|---|---|---|
| | | | Melt | Loss of | |
| Protein Source | Texture | Sliceable | Profile | Shape | Stretch |
| Zein | √ | √ | √ | √ | √ |
| Cheddar Cheese | √ | √ | √ | √ | √ |
| Mozzarella Cheese | √ | √ | √ | √ | √ |
| Plant Based (Daiya) | √ | √ | X | X | X |
| Plant Based (Violife) | √ | √ | X | X | X |

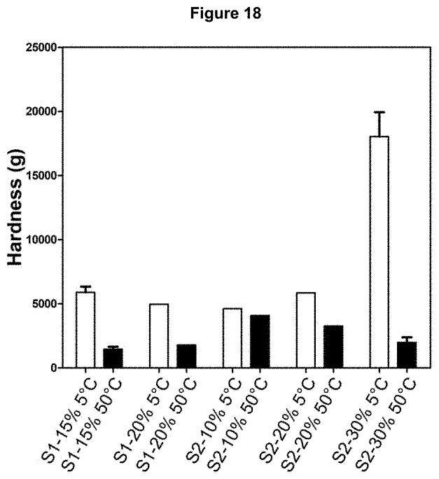

Zein Quantity—The quantity of zein included in the cheese was determined to impact the functionality of the final product. The minimum quantity of zein to provide stretch is not a precise value as it is not based on zein alone, but rather depends on the composition of the surrounding system. In general, the preferred zein concentration is not below 10%, and not above 40%. Increasing zein concentration from 15 to 20% in the same system did not significantly impact the melt profile for the displayed sample. Evident in two different analyzed systems, the hardness is not significantly impacted by an increase in zein concentration in the range of 10 to 20%, however hardness does increase significantly when the zein concentration is increased further to 30% (FIG. 18). Increasing zein concentration does however impact the stretchability in terms of force required to stretch the cheese. The magnitude of force required to stretch the cheese containing 20% zein did increase relative to that at 15% (by almost 2×), and the force recorded was greater throughout the distance of stretch. Regardless, both zein concentrations allowed for stretch over the entire 200 mm distance.

Plasticizer—The use of plasticizers with zein was first of interest for the purpose of decreasing the T_{g} of zein. Zein non-covalent networks formed at temperatures above zein's glass transition temperature (˜40° C.) and revert to brittle behaviour when temperatures drop below this point. This is particularly impactful for a product that will be stored at fridge temperature. The addition of a plasticizer enhances the melt/stretch functionality naturally occurring with zein. The zein product was plasticized using food grade carboxylic acids, including citric, malic and tartaric acid. The functionality achieved by adding a plasticizer to zein can also be achieved by other methods, including by partial hydrolysis of a protein, which was also explored. In general, plasticizers work to decrease the rigidity of the material by reducing the extent of interaction and attraction between polymer chains.

Citric, malic, tartaric, lactic and acetic were each added to isolated zein at different concentrations. HCl (hydrochloric acid) and H₃PO₄ (phosphoric acid) were also included as non-carboxylic comparatives to ensure that any observed effects were not simply a result of lowered pH. All acids were added at concentrations of 1%, 5%, and 20%. In addition to acids, base hydrolysis was also performed on zein, to compare techniques of plasticization. To achieve this, zein was hydrolyzed in 1M NaOH at 60° C. for 20 minutes. Following this, zein was precipitated with 1M HCl.

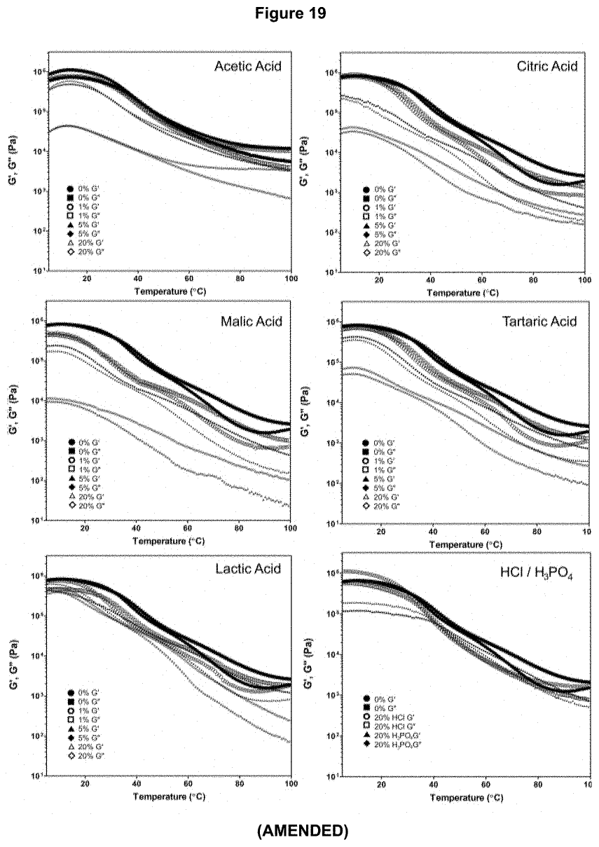

First evaluation looked at zein with plasticizer in isolation (without the surrounding cheese system). Looking at the melting profiles of zein in the presence of difference acids, it is easily apparent from the graph that citric, tartaric and malic acid are comparable in their plasticization effect (FIG. 19). For each, increasing the acid concentration produced an increasing reduction in G′ and G″ values at elevated temperatures. The acetic acid was also effective at plasticizing, however to a lesser degree. Lactic acid was less effective, only minimally plasticizing the zein network relatively. The two non-carboxylic options are displayed at only 20% concentrations in order to emphasize the fact that no plasticization occurred even at the maximum studied concentration.

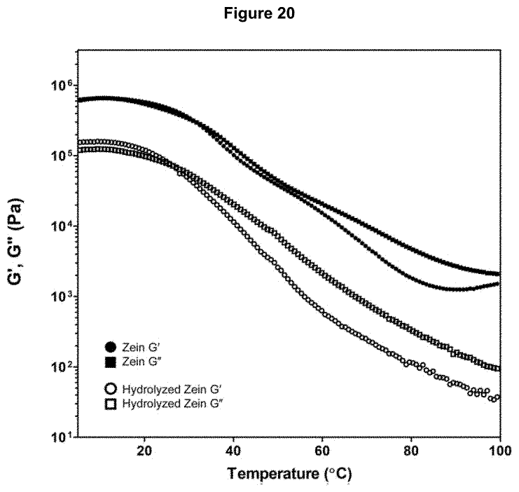

As a comparative to the acid plasticized zein, partial hydrolysis resulted in zein that was highly plasticized, where the material demonstrated reduced G′ and G″ values at both low and high temperatures (FIG. 20). This result indicates that base hydrolysis also presents an option for effective plasticization.

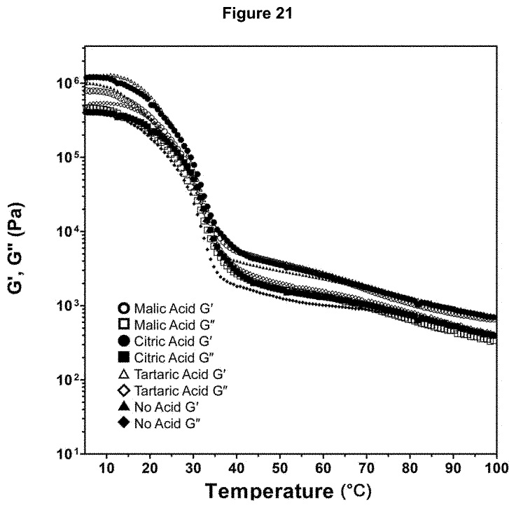

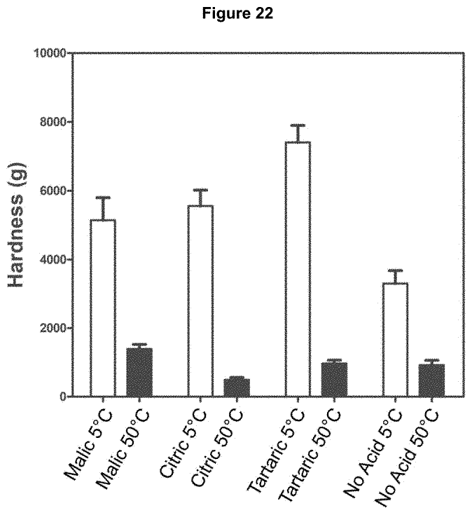

Properties of zein cheese with and without acids—Zein cheeses comprising about 15-20% zein, 20-25% fat and 5-15% gelling/thickening agents, 5-10% filler, each by weight of the product, and water, were made with and without plasticizer and analyzed primarily for melt and stretch functionality. Samples prepared with malic, citric and tartaric acid as the plasticizer each demonstrated suitable melting, both in terms of the rheological profile and loss of shape. From the rheological melting profile of cheeses containing the different acids (˜2% w/w), or cheeses containing no acid, it is easy to conclude that there are minimal differences in the melt profile of each of these samples, even when acid was removed (FIG. 21). In addition, all samples demonstrated loss of shape upon melting, and the diameter increase was comparable even without acid. It should however be noted that when zein concentration is increased to levels of 20-30%, the removal of acid was found to slightly reduce the melting diameter of the cheeses. From a texture perspective, TPA revealed that samples containing no acid did demonstrate reduced hardness at low temperatures (FIG. 22). The results are summarized in Table 12.

TABLE 12
Melting Diameters after Loss of Shape

| Fat Source | Diameter Increase Factor |
|---|---|
| Malic | 2× |
| Citric | 2.1× |
| Tartaric | 2.2× |
| No Acid | 2.2× |

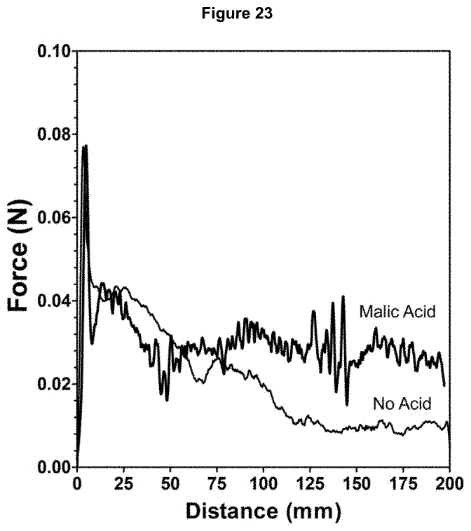

The most notable effect of acids was the obvious contribution to stretchability. A cheese containing no acid demonstrated a significant loss of stretching functionality, visualized as a reduction of force during stretch as shown in FIG. 23, while cheese containing an acid exhibited retention of an increased force during stretch. This therefore indicates that a plasticizer component enhances the stretch functionality in these cheese products.

TABLE 13
Summary of Functionality-Cheeses with and without Plasticizers

| | Functionality | | | | |
|---|---|---|---|---|---|
| | | | Melt | Loss of | |
| Plasticizer | Hardness | Sliceable | Profile | Shape | Stretch |
| Citric Acid | √ | √ | √ | √ | √ |
| Malic Acid | √ | √ | √ | √ | √ |
| Tartaric Acid | √ | √ | √ | √ | √ |
| None | X | √ | √ | X | X |

(Check marks indicate that the plasticizer was not observed to inhibit the listed functionality, X indicates interference can occur)

Plasticizers and Salt—Table salt (NaCl) has a negative impact on zein network formation, making the network harder and more brittle. The effect of salt can therefore be considered as the opposite of the effect of a plasticizer. To evaluate this aspect, networks were prepared with and without malic acid, and increasing concentrations of salt were added (see compositions detailed in Table 14). The samples were held at 40° C. and evaluated using a 3 Point Bend measurement with a texture analyzer, which measures the force required to bend the sample.

TABLE 14
Salt and Acid Sample Composition

| | Salt Samples | | | | Acid/Salt Samples | | | |
|---|---|---|---|---|---|---|---|---|
| Ingredient | Control | 1 | 2 | 3 | Control | 1 | 2 | 3 |
| Zein | 25% | 24.4% | 23.4% | 21.4% | 24.4% | 23.8% | 22.9% | 20.9% |
| Malic Acid | — | — | — | — | 2.4% | 2.4% | 2.3% | 2.1% |
| Salt | — | 2.4% | 6.25% | 14.3% | — | 2.4% | 6.1% | 14% |
| Water | 75% | 73.2% | 70.3% | 64.3% | 73.2% | 71.4% | 68.7% | 63% |

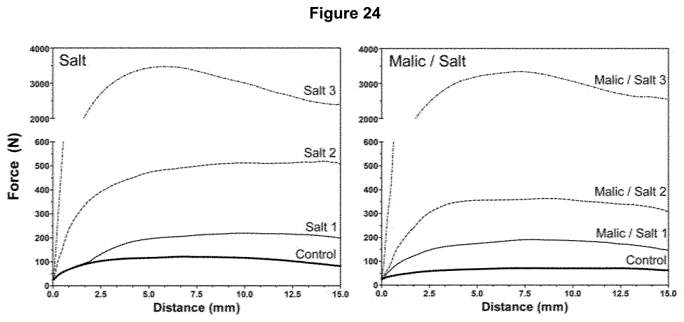

Increasing the salt concentration increases the hardness of the sample, in addition to increasing the brittle characteristics as shown in FIG. 24. However, the addition of malic acid as a plasticizer helps to soften the cheese network when compared to samples containing equivalent amounts of salt. Thus, the impact of salt can be at least partially counteracted through the use of a plasticizer in a cheese system.

Fat—The inclusion of a fat component aids in achieving the cheese like appearance and sensory attributes, including contributing to the melting of the material, the leaking of oil, and the coating of oil in the mouth upon consumption. Cheeses naturally contain a high proportion of fat. The amount of fat can be significant, however the maximum is limited by the system in terms of how much fat can be either emulsified and/or physically entrapped by the matrix.

Properties of Zein Cheese with and without a fat component—The primary focus when formulating zein cheeses is ensuring that zein itself can function in the desired ways, e.g. to form the desired non-covalent network. The fat component was found to contribute to a more cheese-like melting experience. The described melting behaviour is enhanced by the use of a solid fat, a fat which is solid at fridge temperatures (about 4° C.) but melts to a liquid state once heated above ambient temperatures (e.g. greater than about 24° C.).

Cheese products comprising in the range of about 15-25% zein, 5-15% gelling/thickening agents, 5-10% filler, about 2% plasticizer, each by weight of the product, and water, were prepared using different fats, e.g. coconut oil, canola oil and cocoa butter (20-25% by weight), and containing no fat component at all.

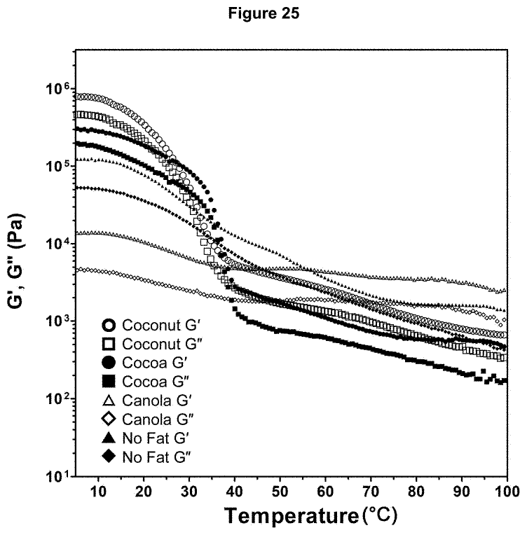

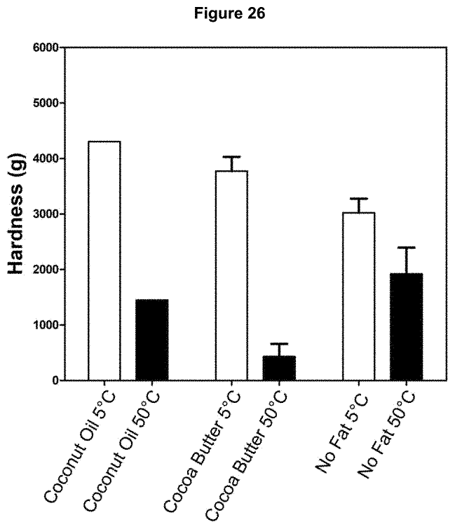

The use of different solid fats (coconut oil and cocoa butter) did not significantly impact the stretching nor melting behaviour (FIG. 25 and Table 15). The hardness of the cheeses with solid fats (coconut and cocoa) was also not significantly different (FIG. 26). This suggests that solid fat sources could be used interchangeably in the product while maintaining required functionality. The use of liquid oil (canola oil) in the product inhibited the formation of structure in the product, to the point that the cheese resembled a very soft paste-like cheese. For this reason, pieces could not be formed to properly perform TPA, however a qualitative lack of hardness and sliceability was notable. Additionally, the lack of solid fat melting prevented a significant decrease in G′ and G″ values as temperature increased, resulting in an almost horizontal melt profile (FIG. 25). The removal of fat entirely from the system resulted in a softer cheese, but the more significant impact was the lack of softening at higher temperatures when compared to solid fat samples. The removal of fat impeded the melting behaviour, demonstrating a reduced increase in diameter upon melting (Table 15), and a flatter melting profile (FIG. 25). Although, it is interesting to note that a more horizontal profile was observed for canola oil samples than for fat free samples, highlighting the fact that zein itself contributes significant melting behaviour on its own.

TABLE 15
Melting Diameters after Loss of Shape

| Fat Source | Diameter Increase Factor |
|---|---|
| Coconut Oil | 2× |
| Cocoa Butter | 2.1× |
| Canola Oil | 1.6× |
| No Fat | 1.4× |

These observations confirm the potential to alter the fat component within a prolamin cheese product to result in cheeses of different types, e.g. the use of a greater solid fat content to yield cheddar-like cheeses, the use of a greater liquid oil content to yield soft Brie-like cheeses, and the use of reduced fat content to yield harder cheeses like parmesan.

Thickening and/or Gelling Component: Zein on its own does exhibit some stretching and melting functionality, however, to optimize other aspects of cheese functionality and sensory properties (properties at fridge temperatures, e.g. hardness), adding a gelling component aids in creating a softer, more chewable product at cold temperatures, and helps to retain or emulsify the fat component within the system. For this reason, the gelling/thickening component may be referred to as the “base” of the product. The gelling/thickening component may comprise additional components that create initial viscosity, emulsify fat and water within the system, and that display thermos-reversible gelling behaviour. Additionally, a filler may be included to fill volume as necessary, but acts as an inert component that does not add nor take away from the desirable functionality.

During cheese production, the gelling/thickening component is hydrated, heated and cooled prior to zein addition. Aside from the functions listed above, the viscosity of the mixture is then tuned to allow for zein incorporation. Specifically, the zein and optional acid component are added to the mixture at a temperature that allows for zein network formation (above its glass transition temperature). Under optimal conditions, the viscosity of this mixture allows for zein to form a network that is uniformly distributed throughout making a dough-like consistency. In the absence of a gelling/thickening agent, the viscosity of the mix may be too low, resulting in aggregation of zein rather than being kneaded into a dough-like mass. An increased viscosity creates a physical barrier for the zein network, preventing excessive aggregation and instead allows for a continuous network to form. The formation of a continuous network is desirable for two main reasons. The first is simply related to texture, where aggregated zein clumps within the system and makes the product grainy and undesirable in terms of mouthfeel. The formation of a continuous network also ensures homogeneity in terms of distribution throughout the product, ensuring that the stretching behaviour observed will be consistent throughout the product. Increasing the viscosity beyond this point, or the inclusion of strong gelling components (that form solid, highly elastic gels), inhibits the formation of a zein network.

In evaluating the thickening and/or gelling component, additional functionality criteria were added in order to capture all aspects of the final cheese product. These additional aspects include the ability of the system to hold oil, and the ability of the system to support the formation of a continuous zein network.

TABLE 16
Summary of all functionality criteria

| Criteria | Description |
|---|---|
| Sliceable | Refrigerated samples can be sliced while otherwise |
| | maintaining shape and without fracturing |
| TPA Hardness at | Recorded as the maximum force recorded during |
| 5° C. and 50° C. | the first compression of a TPA double compression |
| | cycle, taken at different temperatures to quantify |
| | any softening that occurs. |
| Rheological Melt | G′ and G″ values decrease significantly with |
| | increasing temperature, and the tan δ approaches |
| | or is greater than 1. |
| Loss of Shape | Samples measuring 10 mm (height) by 20 mm |
| | (diameter) will increase by up to or greater than 2× |
| | in diameter when heated over 60° C. |
| Stretch | Melted samples (at or above > 50° C.) exhibit |
| | stretch up to or greater than 5× initial height |
| | determined by pulling with a fork, or by separating |
| | pieces using a specially designed stretching |
| | attachment with a texture analyzer. |
| Oil Held | Oil did not separate or leak out from the protein/ |
| | starch phase during cheese preparation (does not |
| | include oil leakage upon melting) |
| Zein Network | Zein forms a network during cheese preparation |
| | that is continuous and homogenous in distribution. |
| | The absence of this network was observed when |
| | zein chunks or granules were present in the system. |

Different Thickening and/or Gelling Ingredients—Before comprehensive analysis of samples, preliminary screening of potential ingredients was performed to determine the effects of various thickening and gelling agents. In this part, a general cheese formulation was used, e.g. comprising about 15-20% zein, 20-25% fat and 5-15% gelling/thickening agents, 5-10% filler, about 2% plasticizer, each by weight of the product, and water. Various gelling/thickening agents were used within the cheese formulation as set out in Table 17. The screening involved primarily visual observations to establish whether samples were sliceable, stretchable, melt-able (loss of shape only), held oil, and formed a continuous zein network. The results of this screening are summarized in Table 17. As can be seen, the properties of a cheese product may be varied by varying the thickening and gelling agents within the product.

TABLE 17
Summary of Ingredient Effects

| | | | | Loss of | Oil | Zein |
|---|---|---|---|---|---|---|
| Ingredient | Role | Sliceable | Stretch | Shape | Held | Network |
| Agar | Gelling | X | √ | √ | √ | X |
| Gellan Gum (Ticagel Gellan HS) | Gelling | √ | √ | X | X | X |
| Guar Gum | Thickening/Gelling | √ | X | X | √ | √ |
| Locust Bean Gum | Thickening | √ | √ | √ | √ | √ |
| K-Carrageenan | Thickening/Gelling | X | X | X | √ | X |
| K-Carrageenan and Locust Bean | Thickening/Gelling | X | X | X | √ | X |
| Gum Blend (Tigagel 500 FL) | | | | | | |
| Konjac Gum | Thickening/Gelling | √ | √ | X | √ | √ |
| Konjac/Agar blend (Tigagel | Thickening/Gelling | √ | √ | √ | √ | √ |
| Bind 55-AK) | | | | | | |
| Konjac/Xanthan (Ticagel Bind | Thickening/Gelling | √ | X | X | √ | √ |
| KX) | | | | | | |
| Carboxymethyl cellulose | Thickening | | | | | |
| Xanthan Gum | Thickening | √ | X | X | √ | √ |
| Potato starch (Precisa 604) | Gelling | √ | X | √ | √ | √ |
| Tapioca Starch (Homecraft Express | Thickening | √ | X | √ | √ | √ |
| 390—rapid-swelling) | | | | | | |
| Tapioca Starch (Generic) | Thickening | √ | X | √ | √ | √ |
| Pre-Gel Com Starch (Novation | Thickening | √ | v | √ | √ | √ |
| 4300- rapid-swelling high AP | | | | | | |
| starch) | | | | | | |
| Pre-Gel Com Starch (Novation | Thickening | √ | √ | √ | √ | √ |
| 4600—rapid-swelling high AP | | | | | | |
| starch) | | | | | | |
| Modified Com Starch (N- | Emulsifying | √ | √ | √ | √ | √ |
| Creamer 2000—rapid-swelling high | | | | | | |
| AP starch) | | | | | | |
| Pea Protein (Vitessence) | Emulsifying | √ | √ | √ | √ | √ |
| Pre-Gel modified Com Starch | Thickening | √ | X | √ | √ | √ |
| (Instant Clearjel—rapid-swelling | | | | | | |
| high AP starch) | | | | | | |
| LMA Pectin (with Tricalcium | Gelling | X | √ | √ | √ | X |
| Phosphate) | | | | | | |
| Inulin | Filler | √ | √ | √ | √ | √ |
| Microcrystalline Cellulose | Filler | √ | X | √ | √ | √ |

Check marks indicate that the component was not observed to inhibit the listed functionality, X indicates interference can occur

Characterizing Zein Cheeses Based on the Thickening and/or Gelling Component—As the focus narrowed to specific ingredients, a more in depth analysis of the samples was performed. This included all criteria described previously (Table 16). A standard formulation contained a combination of zein, pre-gelatinized corn starch (PGS), modified corn starch (MCS), pea protein (Vitessence Pulse 1803, Ingredion), agar and konjac gum (Ticagel Bind 55-AK, TIC), inulin (Texturestar), coconut oil (Refined, Nutiva), malic acid (Texturestar) and water. This standard formulation was compared to samples that were produced with systematic modification or removal of each ingredient (within the thickening and/or gelling component) as below (changes in bold):

TABLE 18
Exemplary Standard Formulation

| | Percentage of Composition (%) | | | | | | |
|---|---|---|---|---|---|---|---|
| | | | | | | | No Starch (AK |
| Component | Standard | AK 2x | Agar | Konjac | No MCS | No PGS | Only) |
| Zein | 16.4 | 16.4 | 16.4 | 16.4 | 16.4 | 16.4 | 16.4 |
| PGS | 2.3 | 2.3 | 2.3 | 2.3 | 2.3 | 0 | 0 |
| MCS | 2.0 | 2.0 | 2.0 | 2.0 | 0 | 2.0 | 0 |
| Pea Protein | 1.7 | 1.7 | 1.7 | 1.7 | 1.7 | 1.7 | 1.7 |
| AK Gum | 2.0 | 4.0 | 0 | 0 | 2.0 | 2.0 | 3.0 |
| Agar | 0 | 0 | 2.0 | 0 | 0 | 0 | 0 |
| Konjac | 0 | 0 | 0 | 2.0 | 0 | 0 | 0 |
| Inulin | 5.0 | 3.0 | 5.0 | 5.0 | 7.0 | 7.3 | 8.0 |
| Coconut Oil | 25.0 | 25.0 | 25.0 | 25.0 | 25.0 | 25.0 | 25.0 |
| Water | 44.0 | 44.0 | 44.0 | 44.0 | 44.0 | 44.0 | 44.3 |
| Acid | 1.6 | 1.6 | 1.6 | 1.6 | 1.6 | 1.6 | 1.6 |

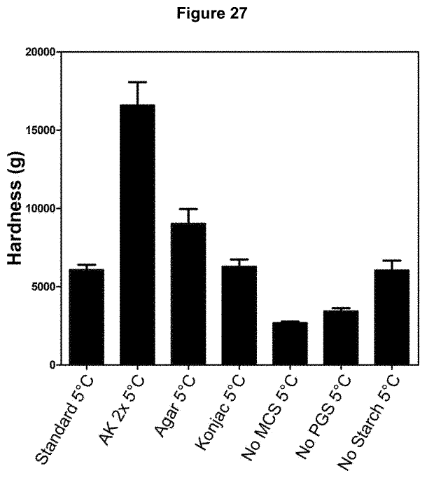

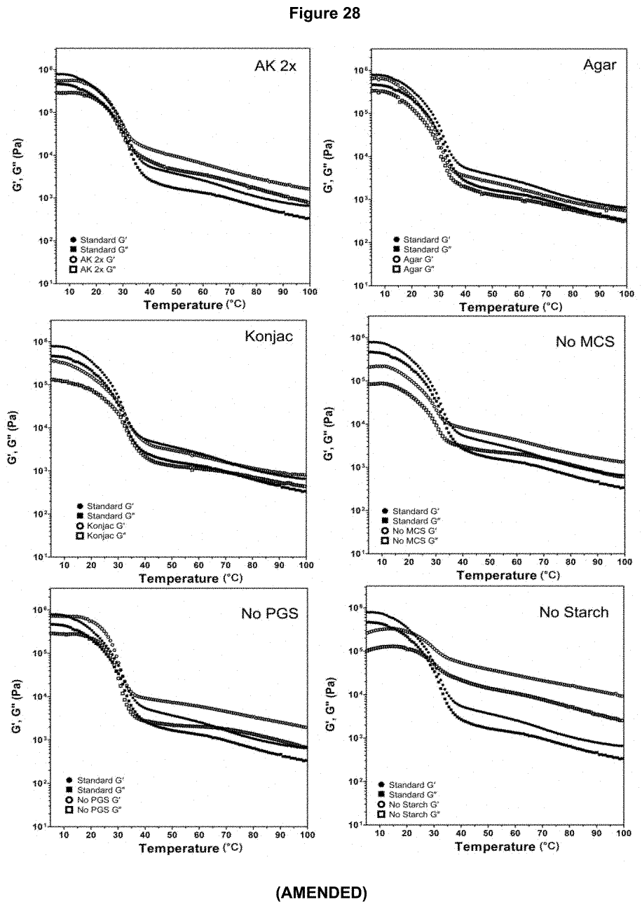

First, increasing the content of Agar Konjac Gum Blend (AK) by 2× resulted in a cheese system that was sliceable, however it did display increased hardness (FIG. 27). The functionality aspect that was most impacted was melting, as the G′ and G″ values reached at high temperatures were greater than the control (FIG. 28), and lost its shape to a lesser extent (Table 19).

Similarly, when all starch components were removed (leaving only the AK gum), the main impact was the rheological melting behaviour, where the plotted melt profile became significantly more horizontal than the standard. The use of only AK gum also resulted in significant oil loss during sample production, but functionality was otherwise largely unaffected.

Replacing the AK with only Agar or Konjac at a 1:1 ratio was also evaluated. Agar allowed for similar melting behaviour as AK, enhanced loss of shape (increased diameter upon melting), and demonstrated comparable stretch to the control sample (qualitatively). The agar also produced a harder cheese at low temperatures, but the hardness still decreased at higher temperatures. However, the ability of zein to form a continuous network was impacted, and instead a more grainy and chunky sample was observed. When the AK gum was replaced with Konjac, the rheological melting profile did not indicate any drastic differences, however the loss of shape upon melting was negatively impacted.

The removal of pre-gelatinized starch (PGS) also had an impact on the functionality of the system. The largest impact noted was the lack of continuous zein network that formed, with chunks and grains noted. Additionally, the network was slightly softer and the melting profile was slightly impacted, where slope of G′ and G″ decreased relative to the standard sample.

The removal of the modified corn starch (MCS) impacted the structure of the cheese since it resulted in the formation of a stronger gel prior to zein addition. This impacted the cheeses by decreasing the hardness, the ability to hold oil, and the ability of zein to form a continuous network. The melting profile was also slightly impacted, where slope of G′ and G″ decreased relative to the standard sample.

TABLE 19
Melting Diameters after Loss of Shape

| Formula | Diameter Increase Factor |
|---|---|
| Standard | 2× |
| AK 2x | 1.75× |
| Agar | 2.35× |
| Konjac | 1.75× |
| No MCS | 1.8× |
| No PGS | 2× |
| No Starch (AK only) | 2× |

Thickening and/or Gelling Component Viscosity—The viscosity of the thickening and/or gelling base (without zein and plasticizer components) was analyzed by subjecting it to conditions that mimicked the thermomix during cheese production. Based on the established importance of creating a base that supports and allows for zein network formation to occur, this analysis was performed in order to correlate the viscosity to conditions primed to support network formation.

The important aspects analyzed here included the viscosity at the end of the process, in addition to monitoring the extent of gelling that occurred. The blends studied here were therefore broken down into three categories: gelling, low viscosity and optimal. The general composition of each blend is detailed in Table 20. It should be noted that when a component was removed (denoted by 0%), the remaining ingredients were kept at the same ratios to one another, such that the remaining percentages were adjusted to equal 100% accordingly.

TABLE 20
General sample composition

| Blend | Ingredient | Percent of Formula |
|---|---|---|
| Optimal Blend 1 | PGS | 2.80% |
| | MCS | 2.44% |
| | Pea Protein | 2.07% |
| | AK Gum | 2.44% |
| | Inulin | 6.10% |
| | Coconut Oil | 30.49% |
| | Water | 53.66% |
| Optimal Blend 2 | PGS | 2.80% |
| | MCS | 2.44% |
| | Pea Protein | 2.07% |
| | Konjac Gum | 2.44% |
| | Inulin | 6.10% |
| | Coconut Oil | 30.49% |
| | Water | 53.66% |
| Gelling Blend 1 | PGS | 2.80% |
| | MCS | 2.44% |
| | Pea Protein | 2.07% |
| | AK Gum | 4.88% |
| | Inulin | 6.10% |
| | Coconut Oil | 28.05% |
| | Water | 53.66% |
| Gelling Blend 2 | PGS | 2.80% |
| | MCS | 0.00% |
| | Pea Protein | 2.07% |
| | AK Gum | 2.44% |
| | Inulin | 8.54% |
| | Coconut Oil | 30.49% |
| | Water | 53.66% |
| Gelling Blend 3 | PGS | 0.00% |
| | MCS | 0.00% |
| | Pea Protein | 2.07% |
| | AK Gum | 3.66% |
| | Inulin | 9.76% |
| | Coconut Oil | 30.49% |
| | Water | 54.02% |
| Low Viscosity Blend 1 | PGS | 2.80% |
| | MCS | 2.44% |
| | Pea Protein | 2.07% |
| | AK Gum | 0.00% |
| | Inulin | 8.54% |
| | Coconut Oil | 30.49% |
| | Water | 53.66% |
| Low Viscosity Blend 2 | PGS | 0.00% |
| | MCS | 2.44% |
| | Pea Protein | 2.07% |
| | AK Gum | 2.44% |
| | Inulin | 8.90% |
| | Coconut Oil | 30.49% |
| | Water | 53.66% |
| Low Viscosity Blend 3 | PGS | 2.80% |
| | MCS | 2.44% |
| | Pea Protein | 2.07% |
| | Agar Powder | 2.44% |
| | Inulin | 6.10% |
| | Coconut Oil | 30.49% |
| | Water | 53.66% |

The functionality discussed in this section pertains only to the ability of a cheese with the corresponding thickening and/or gelling blend to hold oil in the system, to support the formation of a continuous zein network within, and the ability of the resultant cheese to stretch.

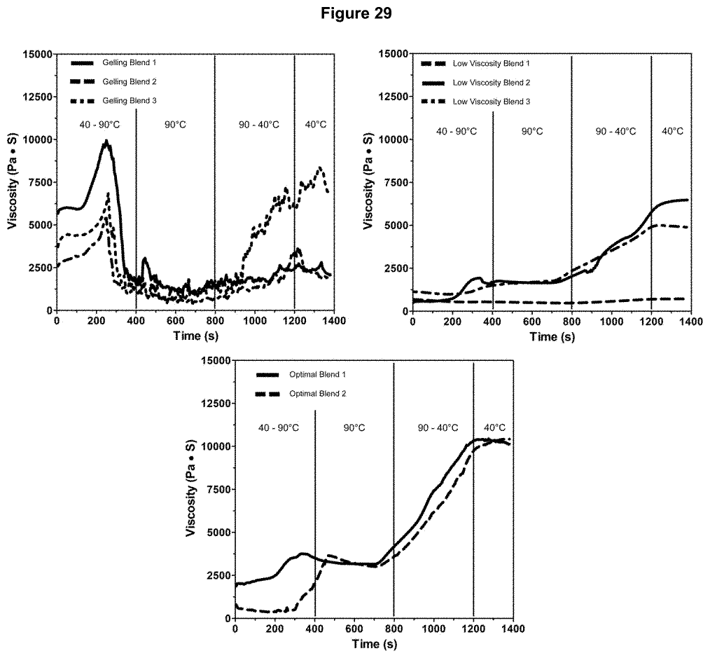

The viscosity as measured throughout the process is depicted in FIG. 29. The gelling blends all reached a gelling point at approximately 80° C. (˜250 s into the process). After this point, the masses were so strongly gelled that they spun around attached to the probe resulting in the loss of usable signal. These blends, when used in cheese production, were each correlated to a lack of oil holding and a lack of network formation. The strongly gelled networks therefore do not allow for the incorporation of additional material after the gel structure is formed. Interestingly, stretch could still be observed in these samples.

The low viscosity blends were each correlated to cheeses that had a notable lack of continuous network formation, i.e. lack of supporting structure. Instead, grainy or chunky zein pieces were noted. As a result of the low viscosity, stretch was at times impacted, again related to the lack of supporting network. However, each of the low viscosity blends was correlated with the ability to hold oil in the system.

The optimal blends were named as such due to balancing the need for a high enough viscosity, while also not forming strongly elastic gels. These blends were correlated with cheeses that demonstrated desirable functionality in terms of each oil holding, stretch and network formation. These blends exhibited gelling on cooling, e.g. to a temperature below the glass transition temperature of zein, thereby permitting network formation on addition of zein at increased temperatures, i.e. a temperature above the glass transition temperature of zein.

The experimental work demonstrates that modification of the components of the prolamin cheese product within acceptable ranges permits the ability to produce a range of cheese products that correlate with actual cheese products.

1. A plant-based cheese product comprising a plant prolamin combined with a fat, and a structural component in water, to yield a cheese product comprising a prolamin non-covalent network.

2. The plant-based cheese product of claim 1, wherein the product is stretchable in an amount of about 100% in a linear direction from a resting or baseline position without breaking at 50° C.

3. The plant-based cheese product of claim 1, wherein the product exhibits:
i) a melting profile in which the tan 6 increases from about 0.2-0.5 to about 2.0 as temperature is increased from room temperature up to about 100° C.; or
ii) a melting profile such that the storage modulus (G′) is greater than loss modulus (G″), and tan δ (G″/G′) is greater than 0.5 but less than 1.0.

4. The plant-based cheese product of claim 1, wherein the product exhibits a decrease in hardness and loss of shape at a temperature of greater than 20° C. as compared to the hardness of the product at 5° C.

5. The plant-based cheese product of claim 1, wherein the prolamin is selected from the group consisting of gliadin, hordein, secalin, zein, kafirin, avenin, or combinations thereof.

6. The plant-based cheese product of claim 1, wherein the prolamin comprises zein or a functionally equivalent derivative thereof.

7. The plant-based cheese product of claim 1, comprising about 10-30% by weight prolamin, 0.1-25% by weight fat and 1-30% by weight structural component.

8. The plant-based cheese product of claim 1, wherein the fat is selected from the group consisting of sunflower oil, canola oil, safflower oil, soybean oil, avocado oil, olive oil, corn oil, flaxseed oil, almond oil, coconut oil, peanut oil, pecan oil, cottonseed oil, algal oil, palm oil, palm stearin, palm olein, palm kernel oil, rice bran oil, sesame oil, butteroil, cocoa butter, shea butter, shea stearin, shea olein, palm kernel stearin, palm kernel olein, grape seed oil, hazelnut oil, brazil nut oil, linseed oil, acai palm oil, passion fruit oil and mixtures thereof.

9. The plant-based cheese product of claim 1, wherein the fat comprises an oleic acid content of greater than 20% by weight.

10. The plant-based cheese product of claim 1, wherein the structural component comprises a thickening agent and/or a gelling agent.

11. The plant-based cheese product of claim 1, wherein the structural component is selected from the group consisting of a starch, a microbial or vegetable gum, a protein, a sugar polymer, and mixtures thereof.

12. The plant-based cheese product of claim 11, wherein the structural component is selected from the group consisting of arrowroot, cornstarch, katakuri starch, potato starch, sago, wheat flour, almond flour, tapioca, a starch derivative, modified or pre-gelatinized starch, high amylopectin starch, pre-gelatinized high amylopectin starch, alginin, guar gum, locust bean gum, gellan gum, tara gum, Arabic gum, Konjac gum, xanthan gum, collagen, egg white, gelatin, agar, carboxymethyl cellulose, pectin, carrageenan, and mixtures thereof.

13. The plant-based cheese product of claim 1, wherein the structural component is a pre-gelatinized high amylopectin starch.

14. The plant-based cheese product of claim 13, wherein the starch comprises essentially no crosslinking.

15. The plant-based cheese product of claim 1, additionally comprising a plasticizer.

16. The plant-based cheese product of claim 15, wherein the plasticizer is a food grade acid, glycerol, a sugar or mixtures thereof.

17. The plant-based cheese product of claim 15, wherein the plasticizer is a food grade carboxylic acid.

18. The plant-based cheese product of claim 17, wherein the plasticizer is selected from citric acid, malic acid, tartaric acid, lactic acid, acetic acid, oxalic acid and mixtures thereof.

19. The plant-based cheese product of claim 1, comprising a plasticizer in an amount of up to 5% by weight.

20. The plant-based cheese product of claim 1, wherein the prolamin is partially hydrolyzed.

21. The plant-based cheese product of claim 1, wherein the prolamin comprises zein or a functionally equivalent derivative thereof, and the structural component is a pre-gelatinized high amylopectin starch.

22. A method of making a plant-based cheese product as defined in claim 1, comprising the steps of:
i) combining the structural component with water and heating to form a mixture having a viscosity that permits formation of a non-covalent prolamin network at a temperature greater than the glass transition temperature of the prolamin, and
ii) combining the mixture with the prolamin, fat and optionally a plasticizer at a temperature above the glass transition temperature of the prolamin to form the prolamin network; and
iii) cooling the mixture to provide the cheese product.

23. The method of claim 22, wherein the prolamin has a glass transition temperature of greater than 40° C.

24. The method of claim 23, wherein the prolamin is zein.

25. A product comprising a prolamin combined with a plasticizer.


SEQUENCE LISTING (1 sequence)

SEQ ID NO: 1 - protein, 266 aa, Zea mays
MATKILALLALLSLSVSATTAFIIPQCSLAPNAIIPQFLPSVTSMGIEHPIVQAYRLQQALAASVLQQPFAQLQQQSLAHLTIQTIATQLEQQFVPALSQLAAVNPVSYLQQQMLASNPLALANTAAYQQQLQLQQFLPALSQLARVNPATYLQQQQLLSSSPLAVGNAATYLQQQLLQQIVPALSQLVVANPTAYLQQLLPFNQLDVANSAAYLQQRQQLLNPLAAANPLVAAFLQQQQFLPYNQISLMNLALSRQQPIVGGAIF